(19) United States
(12) Patent Application Publication
(10) Pub. No.: US 2026/0212585 A1
(43) Pub. Date: Jul. 23, 2026

(54) VOLUMETRIC VIDEO BASED ON MONOCULAR VIDEO

(71) Applicant: DOLBY LABORATORIES LICENSING CORPORATION, San Francisco, CA (US)

(72) Inventors: Lingdong Wang, Amherst, MA (US); Dae Yeol Lee, San Jose, CA (US); Guan-Ming Su, Fremont, CA (US)

(73) Assignee: DOLBY LABORATORIES LICENSING CORPORATION, San Francisco, CA (US)

(21) Appl. No.: 19/448,436

(22) Filed: Jan. 14, 2026

Related U.S. Application Data
(60) Provisional application No. 63/746,468, filed on Jan. 17, 2025.

(30) Foreign Application Priority Data
Jun. 10, 2025 (EP) 25181855.5

(51) Int. Cl. G06T 15/08; G06T 5/77; G06T 7/194; G06T 7/50

(52) U.S. Cl. CPC G06T 15/08; G06T 5/77; G06T 7/194; G06T 7/50; G06T 2207/20084

(57) ABSTRACT

In one example, a method of generating a volumetric video based on a monocular video includes: obtaining a respective foreground image and a respective background image based on image segmentation of a frame of the monocular video; completing the respective background image by inpainting one or more occluded areas therein based on one or more neighboring frames of the monocular video; computing a background depth map corresponding to the completed background image and a foreground depth map corresponding to the respective foreground image; generating a first multiplane image (MPI) based on the respective foreground image and the foreground depth map; generating a second MPI based on the completed background image and the background depth map; and composing the first and second MPIs into a third MPI representing a frame of the volumetric video corresponding to the frame of the monocular video.

### 1. CROSS-REFERENCE TO RELATED APPLICATIONS

This patent application claims the benefit of priority from U.S. Provisional Patent Application Ser. No. 63/746,468, filed on Jan. 17, 2025 and European Patent Application Ser. No. 25181855.5, filed on Jun. 10, 2025, each of which is incorporated by reference in its entirety.

### 2. FIELD OF THE DISCLOSURE

Various example embodiments relate to volumetric imaging and, more specifically but not exclusively, to generating a volumetric video based on a monocular video.

### 3. BACKGROUND

Volumetric video records a video sequence in 3D, capturing the object or space in three dimensions and in time. The volumetrically captured objects, environments, and/or living beings can be transplanted to the web, mobile, or virtual worlds for being viewed using any suitable rendering equipment, such as VR or AR headsets. A conventional approach to capturing volumetric video includes training multiple cameras on the object or environment to be recorded. After the initial video capture, the scene is processed to produce a set of 3D models arranged in a sequence. Subsequently, the meshes are unwrapped, textures are generated, and the resulting data set is compressed into a video file that can be played and viewed on a suitable playback and rendering device.

Some of the present challenges to generating volumetric content include: (i) the relatively high cost and complexity of the equipment and setups typically needed for de novo capture of volumetric content; (ii) the lack of established guidelines regarding the workflows used in the production of volumetric videos, especially for smaller productions or individuals with lower budgets; and (iii) the substantial time and postprocessing required after volumetric capture to generate usable assets, such as the video files ready for streaming. New technological developments and methodologies are therefore needed to address these challenges.

### BRIEF SUMMARY OF SOME SPECIFIC EMBODIMENTS

One embodiment provides a pipeline that can convert a 2D monocular video into a 3D volumetric video in the form of a multiplane image (MPI) sequence. The pipeline is implemented using a method capable of substantially eliminating blurry shadow artifacts in the occluded regions by separately reconstructing the foreground and background MPIs and then compositing them into a corresponding output MPI. The pipeline realizes a joint correlative-generative inpainting strategy to complete the background. Deflickering and normalization techniques are employed to improve temporal consistency across the sequence of frames and the scene consistency across the foreground and background. Conic occlusion correction and soft composition are used to blend the foreground and background more naturally, e.g., without concomitant artifacts. Diverse experiment results indicate that at least some of the disclosed methods beneficially outperform example baseline methods in visual quality and temporal consistency. In addition, at least some of the disclosed methods advantageously make high-quality 3D content relatively easy to create, stream, and render, thereby providing a valuable contribution to the development of the next-generation 3D content ecosystem.

In one example, an apparatus for generating a volumetric video based on a monocular video comprises: at least one processor; and at least one memory including program code, wherein the at least one memory and the program code are configured to, with the at least one processor, cause the apparatus at least to: obtain a respective foreground image and a respective background image based on image segmentation of a frame of the monocular video; complete the respective background image by inpainting one or more occluded areas therein based on one or more neighboring frames of the monocular video; compute a background depth map corresponding to the completed background image and a foreground depth map corresponding to the respective foreground image; generate a first multiplane image (MPI) based on the respective foreground image and the foreground depth map; generate a second MPI based on the completed background image and the background depth map; and compose the first and second MPIs into a third MPI representing a frame of the volumetric video corresponding to the frame of the monocular video.

In another example, an apparatus for generating a volumetric video based on a monocular video comprises: at least one processor; and at least one memory including program code, wherein the at least one memory and the program code are configured to, with the at least one processor, cause the apparatus at least to: iteratively obtain a plurality of layers representing a frame of the monocular video, the plurality of layers including at least three layers corresponding to different respective nonoverlapping depth ranges, wherein each iteration comprises: obtaining a respective foreground image and a respective background image based on image segmentation of a respective iteration-input image; and completing the respective background image by inpainting one or more occluded areas therein based on one or more neighboring frames of the monocular video; wherein the frame of the monocular video is used as the respective iteration-input image for an initial iteration; wherein the completed respective background image of a preceding iteration is used as the respective iteration-input image for a following iteration, and wherein the at least one memory and the program code are configured to, with the at least one processor, cause the apparatus at least to: for each iteration, generate a respective multiplane image (MPI) based on the respective foreground image obtained in the iteration; for a last iteration, generate an additional MPI based on the completed respective background image of the last iteration; and compose the respective MPIs and the additional MPI into an output MPI representing a frame of the volumetric video corresponding to the frame of the monocular video.

In yet another example, a method of generating a volumetric video based on a monocular video comprises: obtaining a respective foreground image and a respective background image based on image segmentation of a frame of the monocular video; completing the respective background image by inpainting one or more occluded areas therein based on one or more neighboring frames of the monocular video; computing a background depth map corresponding to the completed background image and a foreground depth map corresponding to the respective foreground image; generating a first multiplane image (MPI) based on the respective foreground image and the foreground depth map; generating a second MPI based on the completed background image and the background depth map; and composing the first and second MPIs into a third MPI representing a frame of the volumetric video corresponding to the frame of the monocular video.

In yet another example, a method of generating a volumetric video based on a monocular video comprises: iteratively obtaining a plurality of layers representing a frame of the monocular video, the plurality of layers including at least three layers corresponding to different respective nonoverlapping depth ranges, wherein each iteration comprises: obtaining a respective foreground image and a respective background image based on image segmentation of a respective iteration-input image; and completing the respective background image by inpainting one or more occluded areas therein based on one or more neighboring frames of the monocular video; wherein the frame of the monocular video is used as the respective iteration-input image for an initial iteration; wherein the completed respective background image of a preceding iteration is used as the respective iteration-input image for a following iteration, and wherein the method further comprises: for each iteration, generating a respective multiplane image (MPI) based on the respective foreground image obtained in the iteration; for a last iteration, generating an additional MPI based on the completed respective background image of the last iteration; and composing the respective MPIs and the additional MPI into an output MPI representing a frame of the volumetric video corresponding to the frame of the monocular video.

According to yet another example, provided is a non-transitory computer-readable medium storing instructions that, when executed by an electronic processor, cause the electronic processor to perform operations comprising any one of the above methods of generating a volumetric video based on a monocular video.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 pictorially illustrates a 3D-scene representation with a multiplane image according to some examples.

FIG. 2 is a block diagram illustrating an MPI generation pipeline according to some examples.

FIG. 3 is a block diagram illustrating a workflow of the segmentation module used in the pipeline of FIG. 2 according to some examples.

FIG. 4 is a block diagram illustrating a workflow of the image preprocessing module used in the pipeline of FIG. 2 according to some examples.

FIG. 5 is a block diagram illustrating a workflow of the background inpainting submodule used in the workflow of FIG. 4 according to some examples.

FIGS. 6A-6C pictorially illustrate example inpainting results generated with the workflow of FIG. 5 according to some examples.

FIG. 7 is a block diagram illustrating a workflow of the depth preprocessing module used in the pipeline of FIG. 2 according to some examples.

FIGS. 8A-8C pictorially illustrate certain artifacts that can be corrected with the workflow of FIG. 7 according to some examples.

FIG. 9 shows a difference depth map between the estimated depth maps generated with the workflow of FIG. 7 for the examples illustrated in FIGS. 8A-8C.

FIG. 10 pictorially illustrates various edges and regions detected with the foreground normalization submodule used in the workflow of FIG. 7 in the estimated depth map according to some examples.

FIG. 11 is a block diagram illustrating a workflow of the MPI generation module used in the pipeline of FIG. 2 according to some examples.

FIG. 12 is a block diagram illustrating a workflow of the foreground MPI generation submodule used in the workflow of FIG. 11 according to some examples.

FIGS. 13A-13B pictorially illustrate the padding operations used in the workflow of FIG. 12 according to some examples.

FIGS. 14A-14B pictorially illustrate operations of the occlusion correction submodule used in the workflow of FIG. 12 according to some examples.

FIGS. 15A-15C further pictorially illustrate operations of the occlusion correction submodule used in the workflow of FIG. 12 according to some examples.

FIG. 16 is a schematic diagram illustrating an occlusion removal scheme implemented in the occlusion correction submodule used in the workflow of FIG. 12 according to some examples.

FIGS. 17A-17B pictorially illustrate effects of soft MPI composition used in the workflow of FIG. 11 according to some examples.

FIG. 18 pictorially illustrates a modification of the pipeline of FIG. 2 to provide for a multilayer scene reconstruction according to some examples.

FIG. 19 is flowchart illustrating a method of generating a volumetric video based on a monocular video according to some examples.

FIG. 20 is a block diagram of an example computing device, one or more instances of which can be used to implement various pipelines, workflows, and methods according to some examples.

### DETAILED DESCRIPTION

With recent advances in sensor-equipped edge devices, such as smartphones and VR headsets, volumetric representation from real-world capture is gaining increasing attention for enabling immersive and interactive experiences. For example, volumetric representation methods include Neural Radiance Fields (NeRF), which model the scene as an implicit representation. However, the NeRF representation may face deployability challenges, e.g., because the multilayer perceptron (MLP) weights for every frame need to be transmitted, and it also typically involves MLP evaluations at multiple points along each ray which may adversely affect the rendering time. Another volumetric representation, known as Gaussian Splat, is a more recent explicit point-based representation characterized by faster training and shorter rendering times. Nevertheless, Gaussian Splat may impose a significant burden on data transmission as it usually involves transmission of a relatively large number (e.g., millions) of Gaussian points.

Preferably, for the proliferation of a volumetric media ecosystem, the corresponding 3D content should be easy to create, transmit, and render on various edge devices while maintaining high quality. Example embodiments disclosed herein represent a step forward in the development of such ecosystem by employing an efficient 3D representation referred to as “multiplane image” (or MPI). The MPI represents a captured 3D scene using multiple RGBA planes at different depths. Due to the MPI's high level of compatibility with conventional image/video codecs and relatively low computational loads for rendering, MPI may be currently considered as one of the most deployable solutions among the available volumetric representation options. However, one challenge that hampers a wider proliferation of MPI is that MPI synthesis methods have not reached sufficient maturity and accessibility levels. For example, a large portion of existing MPI synthesis methods remains out of reach for most potential users.

At least some of the above-indicated problems in the state of the art can beneficially be addressed using at least some embodiments disclosed herein. For example, one embodiment provides ReVill-MPI, which is an abbreviation standing for Reconstructing Volumetric video from monocular video by filling occluded areas and compositing with Multi-Plane Image. A disclosed method can beneficially be used to convert a 2D monocular video into a corresponding 3D volumetric video in represented an MPI sequence, substantially without shadow artifacts. The method can be viewed as including the blocks of operations directed at (i) separating the foreground and background, (ii) reconstructing the separated foreground and background in completed forms, and (iii) assembling the foreground and background so reconstructed into an MPI. One example implementation of this sequence of operations is via a novel MPI generation pipeline that leverages, modifies, and adapts certain existing foundational MPI models. In one example, MPI generation pipeline includes and/or uses the following building blocks and/or components:
The pipeline is based on a framework that converts a single monocular video into a volumetric video using MPI representation. In one example, separate MPIs for foreground objects and background are constructed, employing the algorithms designed to accurately handle the textures and opacities in occluded areas. This approach leads to a stable MPI representation when composited, enabling substantially artifact-free novel view rendering.
To fill in the background regions occluded by foreground objects, a joint correlative-generative inpainting strategy is implemented to reconstruct a clean and complete background. In one example, the correlative inpainting uses optical flow to leverage information from neighboring frames of the input video. For the regions that cannot be filled-in based on the neighboring frames, a generative inpainting process employing 2D generative models is used to introduce the pertinent details. Some examples provide a prompt guidance on the generative model to produce stable and convincing textures. Additionally, some examples may use optical-flow-based propagation to extend these generated textures to other frames, thereby providing improved temporal consistency.
Some examples employ methods designed for consistent depth estimation for both the foreground and background. For example, one specific embodiment is configured to apply a video de-flickering technique on the background depth maps to improve the temporal consistency. Additionally, in some examples, intersection-aware and outlier-aware normalization methods are used to maintain consistent depth across the scene, regardless of the object presence/absence. It should be noted that, in some examples, these techniques for temporal and scene consistency can be used to stabilize a suitable off-the-shelf monocular depth estimation method and/or improve the accuracy of subsequent 3D tasks.
Some examples employ a viewing-angle-based opacity correction scheme to substantially prevent the occurrence of artifacts in novel views. One example employs an efficient analytic algorithm for opacity correction that is based on the fronto-parallel geometry of MPI, constructing an invisible cone on the foreground MPI. Some examples also employ soft MPI composition to naturally blend the foreground and background.

Some of the disclosed methods have been evaluated on a variety of video contents. The corresponding empirical results indicate that the evaluated methods tend to significantly outperform baseline methods in terms of the visual quality and temporal consistency. In addition to the novel view synthesis, some embodiments naturally lend themselves to providing an additional capability for volumetric scene editing, e.g., including 3D object addition or removal and background modification. Some embodiments can be beneficially adapted for other settings, such as monocular image input and multi-layer scene reconstruction. Some embodiments enable general (e.g., amateur) users to create volumetric experience from monocular videos, thereby providing a significant boost to the growth and development of the volumetric media ecosystem.

Multiplane images embody a relatively new approach to storing volumetric content. Multiplane imaging can be used to render both still images and video and represents a three-dimensional (3D) scene within a view frustum using, e.g., 8, 16, or 32 planes of texture and transparency (alpha) information per camera. Example applications of MPIs include computer vision and graphics, image editing, photo animation, robotics, and virtual reality.

A multiplane image comprises multiple image planes, with each of the image planes being a “snapshot” of the 3D scene at a certain depth with respect to the camera position. Information stored in each plane includes the texture information (e.g., represented by the R, G, B values) and transparency information (e.g., represented by the alpha (A) values). Herein, the acronyms R, G, B stand for red, green, and blue, respectively. In some examples, the three texture components can be (Y, Cb, Cr), or (I, Ct, Cp), or another functionally similar set of values. There are different ways in which a multiplane image can be generated. For example, two or more input images from two or more cameras located at different known viewpoints can be co-processed to generate a corresponding multiplane image. Alternatively, a multiplane image can be generated using a source image captured by a single camera.

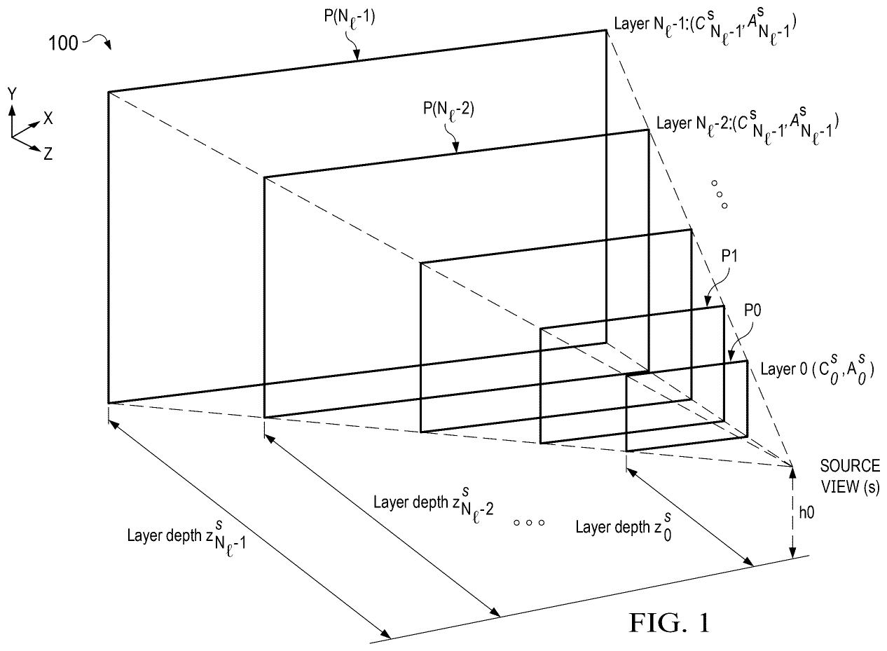

FIG. 1 pictorially illustrates a 3D-scene representation with a multiplane image (100) according to some examples. The multiplane image (100) has Nₗ planes or layers (P0, P1, . . . , P(Nₗ−1)), where Ni is an integer greater than one. Typically, the planes (layers) are indexed such that the most remote layer, from the source view (s) (which may also be referred to as the reference camera position (RCP)), is labeled as the (Nₗ−1)-th layer. The index is decremented by one for each next layer located closer to the RCP. The plane (layer) that is the closest to the RCP is the layer (P0). Each of the planes (P0, P1, . . . , P(Nₗ−1)) is orthogonal to a base plane which is parallel to the XY-coordinate plane. The RCP is at a vertical height h0 above the base plane. The XYZ triad shown in FIG. 1 indicates the general orientation of the multiplane image (100) and the planes (P0, P1, . . . , P(Nₗ−1)) with respect to the X, Y, and Z dimensions of the 3D scene. In various examples, the number Nₗ can be 32, 16, 8, or any other suitable integer greater than one.

Let us denote the three channel RGB plane of the i^{th} layer at camera position s as

$${C}_{i}^{s} .$$

Similarly, let us denote the one-channel α plane of the i^{th} layer at camera position s as

$${A}_{i}^{s} .$$

Each i^{th} MPI layer has a four-channel RGBA plane denoted as

$$( {C}_{i}^{s} , {A}_{i}^{s} ) .$$

The whole MPI (100) can thus be collectively represented as:

$$MPI ( s ) = {\{ ( {C}_{i}^{s} , {A}_{i}^{s} ) \}}_{i = 0}^{{N}_{l} - 1} \qquad ( 1 )$$

The MPI dimension is Nₗ×4×h×w. The h and w refer to the resolutions of height and width of the original reference view (without moving camera), denoted as I^{S}. The depth distance between the i^{th} layer to the reference camera position is

$${z}_{i}^{s} .$$

Note that the distance between two neighboring layers does not need to be a fixed equal interval for different pairs of layers. In some examples, the distances can be adaptive distances, e.g., based on different contents and selected to provide optimal novel view rendering. It is straightforward to extend this still MPI image representation to a video representation, provided that the camera position s is kept static overtime. This video representation is given by Eq. (2):

$$MPI ( s , t ) = {\{ ( {C}_{i}^{s} ( t ) , {A}_{i}^{s} ( t ) ) \}}_{i = 0}^{{N}_{l} - 1} \qquad ( 2 )$$

where t denotes time.

As already indicated above, a multiplane image, such as the multiplane image (100), can be generated from a single source image R or from two or more source images. Such generation may be performed, e.g., during the production phase. The corresponding MPI generation algorithm(s) may typically output the multiplane image (100) containing XYZ-resolved pixel values.

By processing the multiplane image (100) represented by

$${\{ ( {C}_{i}^{s} , {A}_{i}^{s} ) \}}_{i = 0}^{{N}_{l} - 1} ,$$

an MPI-rendering algorithm can generate a viewable image corresponding to the RCP or to a new virtual camera position that is different from the RCP. An example MPI-rendering algorithm (often referred to as the “MPI viewer”) that can be used for this purpose may include the steps of warping and compositing. Other suitable MPI viewers may also be used. The rendered multiplane image (100) can be viewed, e.g., on a display device.

During the warping step of the MPI-rendering algorithm, each MPI layer

$$( {C}_{i}^{s} , {A}_{i}^{s} )$$

needs to be warped from the source view s to a novel target view t. This can be done by applying homography warping W(·) which establishes a correspondence between the source pixel coordinates (x^{s}, y^{s}) and the target pixel coordinates (x^{t}, y^{t}). The correspondence for the i^{th} MPI layer is given as:

$$[ \begin{matrix}{x}^{s} \\ {y}^{s} \\ 1\end{matrix} ] = {K}^{s} ( R - \frac{{tn}^{T}}{{z}_{i}^{s}} ) {( {K}^{t} )}^{- 1} [ \begin{matrix}{x}^{t} \\ {y}^{t} \\ 1\end{matrix} ] \qquad ( 3 )$$

where K^{S} and K^{t} are the intrinsic camera parameters at the source (s) and target (t) positions, respectively. The functions R and t are the extrinsic camera parameters describing rotation and translation between two camera positions. The n is the normal vector [0 0 1]^{T}and

$${z}_{i}^{s}$$

is the distance to a plane that is fronto-parallel to the source camera. The warp amount is different for different layers due to the effect of layer depth

$$( {z}_{i}^{s} )$$

### in Eq. (3).

We express each MPI layer that have been warped from view s to view t as

$$( {C}_{i}^{( s \to t )} , {A}_{i}^{( s \to t )} ) .$$

During the compositing step of the MPI-rendering algorithm, we can render a novel view I^{(s→t)} using these warped MPI layers, e.g., using processing operations corresponding to the following equations:

$${I}^{( s \to t )} = {\sum }_{i = 0}^{{N}_{l} - 1} {C}_{i}^{( s \to t )} {W}_{i}^{( s \to t )} \qquad ( 4 )$$

where the weights

$${W}_{i}^{( s \to t )}$$

are expressed as:

$${W}_{i}^{( s \to t )} = {A}_{i}^{( s \to t )} \cdot {\prod }_{j = 0}^{i - 1} ( 1 - {A}_{j}^{( s \to t )} ) \qquad ( 5 )$$

$$The weight {W}_{i}^{( s \to t )}$$

represents the visibility weight of the i^{th} color channel, where values for each layer at each pixel location are determined by the ray presence up until the current layer times the surface opacity of the current layer as expressed by Eq. (5).

Depth information can take multiple forms of representation. One form is the ‘depth’ referring to the distance between an observer's (or camera's) position to the specific point in the 3D scene. The i-th layer's depth

$$( {z}_{i}^{s} )$$

indicated in FIG. 1, for instance, use this form of the ‘depth’ representation.

Another form of representation is referred to as the ‘disparity’. The ‘disparity’ represents the horizontal shift between the corresponding points of the left and right images of a stereo pair. Some depth databases provide stereo image pairs along with their disparity maps to aid tasks like depth estimation, 3D scene reconstruction, or other depth-aware computer vision applications. Various depth estimation models trained on these datasets learn to output a disparity map from the given images. Some examples of the proposed framework are based on this disparity representation, where the depth of each MPI layer is specified using a disparity vector (d^{s}), and the depth information of multiple views is provided in the form of disparity maps. Herein, the disparity map refers to a one-channel 2D plane having the same width and height as the corresponding image. Each pixel of this 2D plane stores the disparity value of the corresponding image pixel. In some examples, these values are normalized to fall within the [0,1] range, where higher disparity values (i.e., values that are closer to one) signify closer distances with respect to the observer.

We note that, although the rendering algorithm can mainly operate in the disparity domain, it needs to convert the MPI's disparity vector (d^{s}) to the depth vector (z^{S}) when applying the warping operation expressed by Eq. (3). For this conversion, the algorithm needs to “know” the depth range ([zₙₑₐᵣ, z_{far}]) of the scene. For typical contents for depth related tasks, this depth range is usually provided along with the camera parameters. When not provided, it can be obtained using a suitable alternative method, such as COLMAP. Assuming we have these depth ranges available, we first convert the depth ranges to a corresponding disparity representation as:

$${d}_{near} = 1 / {z}_{near} \qquad ( 6 )$$

$${d}_{far} = 1 / {z}_{far} \qquad ( 7 )$$

Then, we apply min-max normalization on the disparity vector (d^{s}) to obtain the rescaled disparity vector (\tilde{d}^{s}). If we denote the i-th element of the disparity vector d^{s} as

$${d}_{i}^{s}$$

and the i-th element of the rescaled disparity vector

$${\tilde{d}}^{s} as {\tilde{d}}_{i}^{s} , then :$$

$${\tilde{d}}_{i}^{s} = ( \frac{{d}_{i}^{s} - min ( {d}^{s} )}{max ( {d}^{s} ) - min ( {d}^{s} )} ) ( {d}_{near} - {d}_{far} ) + {d}_{far} \qquad ( 8 )$$

$$Note that {\tilde{d}}_{i}^{s} , {d}_{i}^{s} ,$$

dₙₑₐᵣ, and d_{far} are scalar values. The min(d^{s}) and max(d^{s}) are also scalar values, with each representing the minimum and maximum values, respectively, from the vector d^{s}. Through Eq. (8), we are rescaling the disparities to cover the ranges of ([d_{far}, dₙₑₐᵣ]). By taking the reciprocal of each

$${\tilde{d}}_{i}^{s} ,$$

we obtain the depth value

$${z}_{i}^{s} as follows :$$

$${z}_{i}^{s} = \frac{1}{{\tilde{d}}_{i}^{s}} \qquad ( 9 )$$

The resulting depth vector (z^{s}) properly covers the depth range [zₙₑₐᵣ, z_{far}] of the scene.

In various examples, the multiplane image (100) can be generated from multiple views or from a single view. In one example single-view-based approach, the source view and its depth information can be used to generate MPI layers with adaptive depth distances. The adaptive depth can be used to optimize the allocation of layers per scene, which facilitates efficient layer utilization from a data transmission standpoint. However, this method may have limitations in terms of the range of pose spans due to the restricted information from a single view. For example, there might be information loss in occluded areas and significant distortions when transitioning to adjacent views.

In some examples, we adapt AdaMPI to serve as a backbone MPI generator. In other examples, other suitable MPI generators can also be used. While some MPI methods evenly position planes with the same disparity (distance between adjacent planes), AdaMPI uses a Plane Adjustment Network to predict varying disparities. As a result, AdaMPI can better adapt to the diverse structure of input contents, thereby improving the overall reconstruction quality. A more-detailed description of AdaMPI can be found in Han, Yuxuan, Ruicheng Wang, and Jiaolong Yang, “Single-view view synthesis in the wild with learned adaptive multiplane images,” ACM SIGGRAPH 2022 Conference Proceedings, which is incorporated herein by reference in its entirety. Modifications and adjustments to AdaMPI used in various embodiments are described in more detail below.

Semantic segmentation can classify each pixel of an image into a semantic class. Single-frame segmentation methods represented by SAM produce an accurate segmentation task given a few guidance clicks from the user. Video object tracking methods, like Cutie, can then be used to propagate the mask across a video. SAM2 is configured to perform video segmentation in an end-to-end manner through its memory mechanism. Semantic segmentation can accept text prompts instead of clicks when used together with image grounding, or bounding boxes automatically generated by object detection algorithms. SAM, SAM2, and Cutie are described in more detail in the following respective publications: (1) Alexander Kirillov, et al., “Segment Anything,” Proceedings of the IEEE/CVF International Conference on Computer Vision (ICCV), 2023; (2) Nikhila Ravi, et al., “SAM 2: Segment Anything in Images and Videos,” Arxiv, 2024; and (3) Cheng, Ho Kei, et al., “Putting the Object Back into Video Object Segmentation,” Proceedings of the IEEE/CVF Conference on Computer Vision and Pattern Recognition (CVPR), 2024, all three of which are incorporated herein by reference in their entirety.

Video inpainting aims at completing the missing regions in a video. It can be generally divided into two categories: (i) correlative inpainting and (ii) generative inpainting. Correlative inpainting methods focus on exploring the information within the video, for example, with an optical flow or Transformer structure. Generative inpainting methods utilize prior knowledge outside the video based on Diffusion. An example optical-flow-based correlative inpainting method FGVC is described in more detail in Chen Gao, et al., “Flow-edge Guided Video Completion,” ECCV 2020: 16th European Conference, Glasgow, UK, Aug. 23-28, 2020, Proceedings, Part XII. Springer-Verlag, Berlin, Heidelberg, pp. 713-729, which is incorporated herein by reference in its entirety. An example single-frame generative inpainting method Stable Diffusion V2 Inpainting is described in more detail in Robin Rombach, et al., “High-Resolution Image Synthesis with Latent Diffusion Models,” Proceedings of the IEEE/CVF Conference on Computer Vision and Pattern Recognition (CVPR), 2022, which is also incorporated herein by reference in its entirety.

Depth estimation methods are configured to output a depth map for an input image, predicting the distances of objects from the camera. Depth estimation methods generally fall into two classes: (i) metric depth and (ii) relative depth. Metric depth methods, like Metric3D, predict the absolute depth values of objects. In contrast, relative depth methods like Marigold, estimate the relative positions between objects. Metric3D and Marigold are described in more detail in the following respective publications: (i) Wei Yin, et al., “Metric3D: Towards Zero-shot Metric 3D Prediction from A Single Image,” Proceedings of the IEEE/CVF International Conference on Computer Vision (ICCV), 2023, and (ii) Bingxin Ke, et al., “Repurposing Diffusion-Based Image Generators for Monocular Depth Estimation,” Proceedings of the IEEE/CVF Conference on Computer Vision and Pattern Recognition (CVPR), 2024, both of which are incorporated herein by reference in their entirety.

One limitation of existing MPI methods is the blurry colors behind foreground objects when rendering from novel views. Herein, we refer to such artifacts as shadow artifacts. We realized that there are two possible sources of shadow artifacts. First, existing methods can only typically inpaint blurry background textures at occluded regions. Second, existing methods typically insert wrong opacity that connects the foreground object to the background.

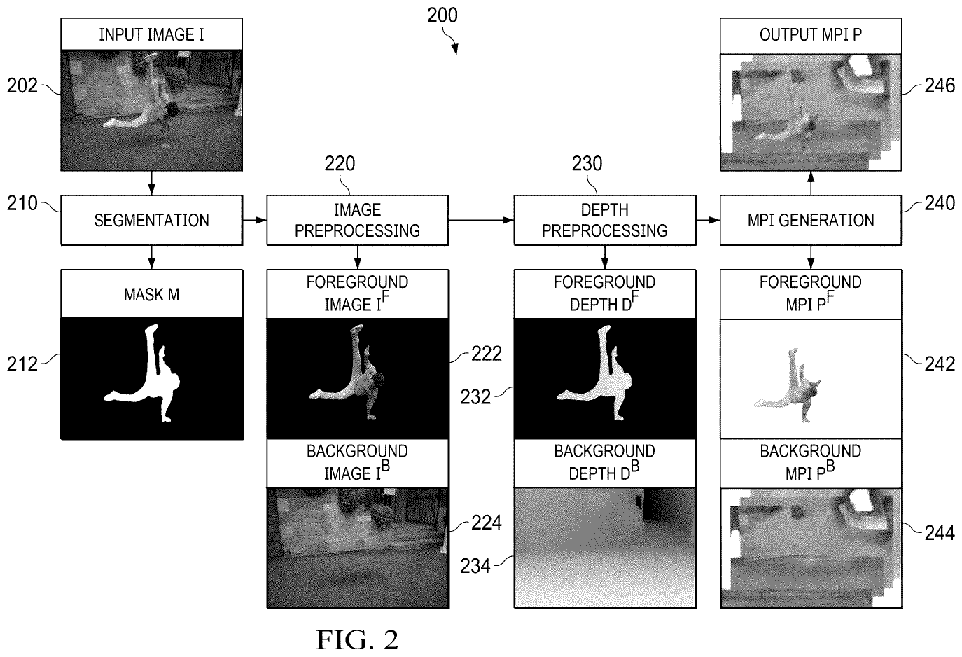

FIG. 2 is a block diagram illustrating an MPI generation pipeline (200) according to some examples. In at least some examples, the pipeline (200) substantially resolves the above-indicated issues and construct a volumetric video from a monocular input. When considered at a high level, the pipeline (200) operates to: (i) separate the foreground and background, (ii) complete both of them independently, and (iii) assemble the resulting completed foreground and background together. In the example shown, the pipeline (200) includes four modules: a segmentation module (210), an image preprocessing module (220), a depth preprocessing module (230), and an MPI generation module (240).

An input to the pipeline (200) includes a 2D monocular video (202) denoted by a sequence of images I={Iₜ∈ [symbol] ^{(3,H,W)}|t=0, . . . , T−1}, where t is the frame index. We will omit the subscript t for simplicity when talking about one individual frame, because we usually apply the same set of operations is typically applied to every frame. First, the segmentation module (210) produces segmentation masks (212) M={Mₜ∈{0,1}^{(H,W)|t=}0, . . . , T−1}. Second, the image preprocessing module (220) generates foreground images

$${I}^{F} = \{ {I}_{t}^{F} ∈ {ℝ}^{( 3 , H , W )} \vert t = 0 , … , T - 1 \} \qquad ( 222 )$$

and completed background images

$${I}^{B} = \{ {I}_{t}^{B} ∈ {ℝ}^{( 3 , H , W )} \vert t = 0 , … , T - 1 \} \qquad ( 224 )$$

via inpainting. Third, the depth preprocessing module (230) outputs consistent foreground depth maps

$${D}^{F} = \{ {D}_{t}^{F} ∈ {ℝ}^{( H , W )} \vert t = 0 , … , T - 1 \} \qquad ( 232 )$$

and background depth maps

$${D}^{B} = \{ {D}_{t}^{B} ∈ {ℝ}^{( H , W )} \vert t = 0 , … , T - 1 \} . \qquad ( 234 )$$

Next, the MPI generation module (240) reconstructs a foreground MPI

$${P}^{F} = \{ {P}_{t}^{F} ∈ {ℝ}^{( K , 4 , H , W )} \vert t = 0 , … , T - 1 \} , \qquad ( 242 )$$

and a background MPI

$${P}^{B} = \{ {P}_{t}^{B} ∈ {ℝ}^{( K , 4 , H , W )} \vert t = 0 , … , T - 1 \} \qquad ( 244 )$$

using the image-depth pairs. In one example, we set the number of MPI planes to K=32. In other examples, other K values can also be used. Finally, the MPI generation module (240) operates to compose the MPIs (242, 244) into an output MPI (246) P={Pₜ∈ [symbol] ^{(K,4,H,W)}|t=0, . . . , T−1}. A more detailed description of each of the modules (210, 220, 230, 240) is provided below.

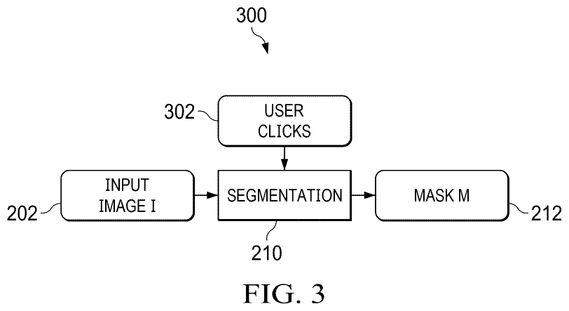

FIG. 3 is a block diagram illustrating a workflow (300) of the segmentation module (210) used in the pipeline (200) according to some examples. The segmentation module's functionality is to segment the foreground object(s) out of the background. In one example, the segmentation module (210) is implemented using the above-mentioned SAM2 the segmentation tool. In other examples, other segmentation tools can also be adapted for use in the segmentation module (210). In the example shown, the segmentation module (210) is configured to receive, as an additional input, one or more user to clicks (302) on the foreground object(s) for one frame. Thereafter, the segmentation module (210) can generate the segmentation masks (212) for all frames of the corresponding video sequence by tracking objects through its memory mechanism. In other examples, the segmentation module (210) can be adapted to accept other spatial indicators, such as text prompts from the user or a bounding box automatically generated by object detection. However, in at least some cases, the user clicks (302) represent a preferred additional input, e.g., because some other indicators may tend to disadvantageously violate the semantic purity of the background, thereby causing an unstable inpainting performance in the downstream blocks of the pipeline (200). In contrast, performance of the segmentation module (210) is rather stable and accurate under direct human (user) supervision, e.g., in the form of the user clicks (302). In some additional examples, the process of generating the clicks (302) can be fully automated, provided that a sufficiently semantically precise auto-segmentation module is available.

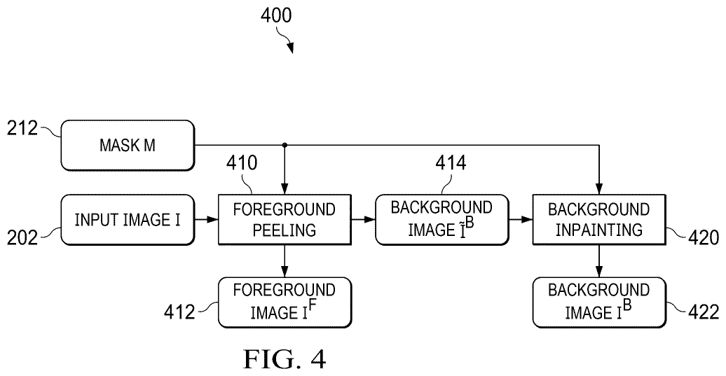

FIG. 4 is a block diagram illustrating a workflow (400) of the image preprocessing module (220) used in the pipeline (200) according to some examples. The image preprocessing module (220) includes a foreground peeling submodule (410) and a background inpainting submodule (420). The overall functionality of the image preprocessing module (220) is to produce two complete images (412, 422) describing the foreground and background, respectively.

The foreground peeling submodule (410) is configured to separate the input image (202) into the foreground image (412) and a complementary background image (414) based on the segmentation mask (212). This operation can be formally expressed by the following equations:

$${I}^{F} = M ⊙ I \qquad ( 10 )$$

$${\tilde{I}}^{B} = ¬ M ⊙ I \qquad ( 11 )$$

where ⊙ denotes pointwise multiplication; ¬ denotes the logical NOT operation; I^{F} is the foreground image (412); and Ĩ^{B} is the background image (414). Note that the background image (414) is typically incomplete, e.g., because the peeling operation performed by the foreground peeling submodule (410) leaves unfilled holes in the image located on the occluded region(s). The background inpainting submodule (420) is used to reconstruct the completed background image (422), e.g., via joint correlative-generative inpainting, by filling up those holes in the background image (414).

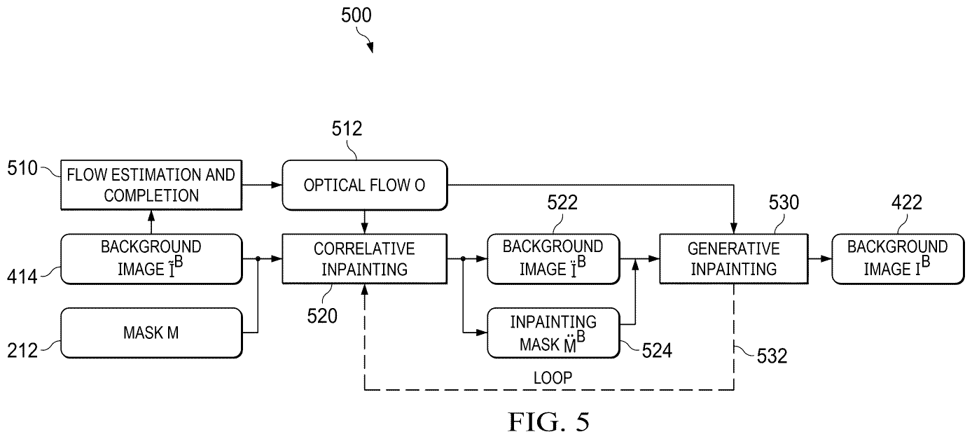

FIG. 5 is a block diagram illustrating a workflow (500) of the background inpainting submodule (420) used in the workflow (400) according to some examples. In the example shown, the background inpainting submodule (420) comprises a flow estimation and completion submodule (510), a correlative inpainting submodule (520), and a generative inpainting submodule (530). In one example, the modules (510, 520) are implemented using respective Flow-edge Guided Video Completion (FGVC)-based tools, and the submodule (530) is implemented using a Stable Diffusion V2 (SD2)-based tool. In other examples, other suitable inpainting tools may also be used.

The correlative inpainting submodule (520) is configured to perform correlative inpainting of the background image (414) to explore the existing correlation within the video, borrowing colors from other frames to complete the current frame. The corresponding FGVC tool (510) starts by estimating an optical flow to depict the pixel motion among adjacent frames. However, in at least some cases, the estimated optical flow may contain holes because of the incomplete input images (414), e.g., as explained above. The FGVC tool (510) operates to connect the broken object edges in the estimated optical flow, and then inpaints the estimated optical flow in a piecewise manner under the guidance of the edges to generate a completed optical flow (512). Given the completed optical flow O (512) for the whole video, the FGVC tool (520) operates to find each pixel's temporal neighbors in other frames. Then, the FGVC tool (520) operates to fill the missing pixels by fetching and fusing the colors from their neighbors. The resulting outputs of the FGVC tool (520) include an inpainted background image Ï^{B}(522) and an inpainting mask \ddot{M}^{B} (524). However, in at least some cases, the inpainted background image Ï^{B}(522) may still be incomplete because correlative inpainting is incapable of recovering the region that is always occluded in the pertinent sequence of video frames. In some cases, such a region may disadvantageously dominate the inpainting task, especially when the input video is lacking sufficient multi-view cues.

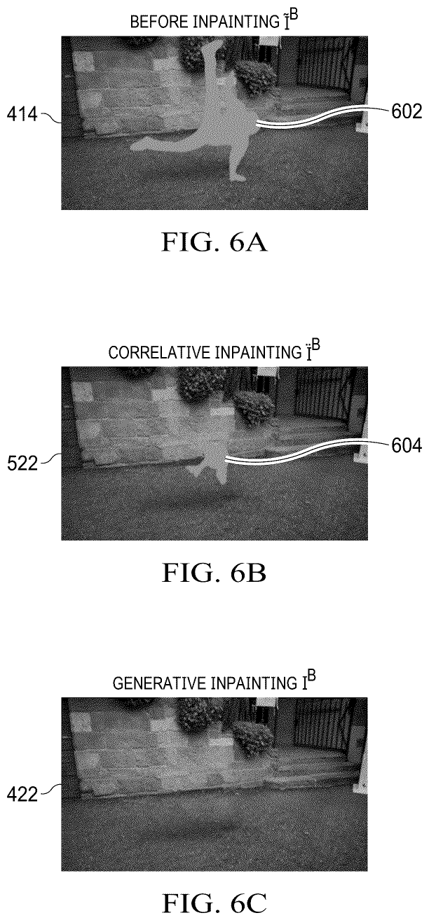

FIGS. 6A-6C pictorially illustrate example inpainting results generated with the workflow (500) according to some examples. More specifically, FIGS. 6A-6C show the background images (414, 522, 422) corresponding to the input image (202) shown in FIG. 2. The solid-color areas (602, 604) in FIGS. 6A and 6B, respectively, represent the missing regions in the background images (414, 522). A comparison of FIGS. 6A and 6B illustrates that the correlative inpainting tools (510, 520) can shrink the missing region(s) but may not be able to completely eliminate them. The generative inpainting submodule (530) is then used to completely eliminate the missing regions, as illustrated by a comparison of FIGS. 6B and 6C.

Once the correlative inpainting has fully utilized the information within the input video, generative inpainting operates to fill the remaining holes (if any), e.g., using a prior knowledge beyond the video sequence at hand. In the example shown, the generative inpainting submodule (530) uses, e.g., SD2 inpainting to perform single frame inpainting, and then propagates the inpainting results across the video using the optical flow (512) to ensure temporal consistency. In other examples, other suitable generative inpainting tools may also be used to implement the generative inpainting submodule (530).

In some examples, the performance of generative model implemented in the generative inpainting submodule (530) can be significantly affected by a short paragraph of input text, which is known as prompt engineering. Positive prompts encourage the model to generate contents as described in the text, while negative prompts encourage the opposite. In some examples, we use the positive prompts, such as “empty space, high resolution, realistic” to promote the generation of an empty background instead of new objects. In some other examples, we use the negative prompt “text” to prevent the occasional failure of the model, e.g., involving a direct insertion of the text “empty space” into the image. In some cases, the generative inpainting submodule (530) may generates noisy content without proper text prompts. As such, based on the various examples, various prompt engineering approaches have been tested, and the approaches leading to the best empirical results have been selected and used with the generative inpainting submodule (530). With such prompts, clean and meaningful background images (422) tend to be generated by the generative inpainting submodule (530) in most cases.

Since single-frame generative inpainting tends to produce a different respective result in each run, the generative inpainting submodule (530) is not designed to simply apply single-frame generative inpainting for every frame. Instead, to ensure temporal consistency in the background, the generative inpainting submodule (530) operates to apply inpainting to the frame of the pertinent video sequence with the largest remaining hole. The generative inpainting submodule (530) then operates to propagate the inpainting result from that particular frame to other frames by rerunning the correlative inpainting step on those frames. This procedure is then iteratively repeated until all holes are filled, resulting in the fully completed background image I^{B} (422). As pictorially illustrated by FIG. 6C, the generative inpainting submodule (530) so configured tends to complete all background holes in the background images (522) with visually pleasing and temporally consistent content.

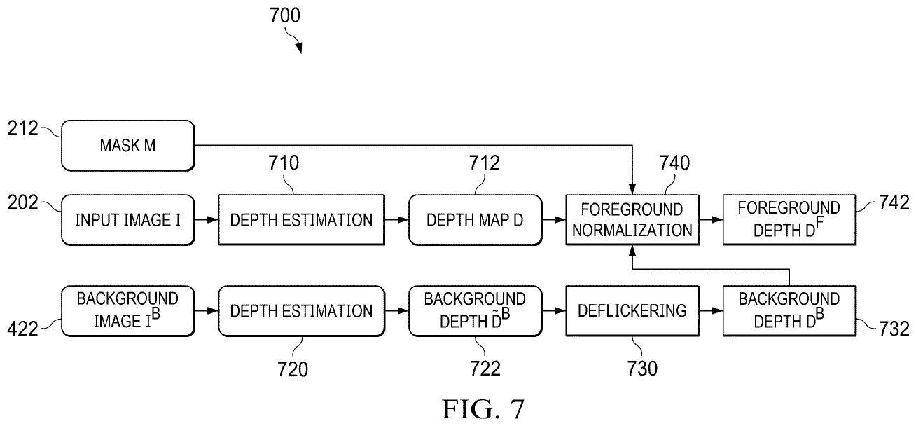

FIG. 7 is a block diagram illustrating a workflow (700) of the depth preprocessing module (230) used in the pipeline (200) according to some examples. The depth preprocessing module (230) includes depth estimation submodules (710, 720), a deflickering submodule (730), and a foreground normalization submodule (740). The overall functionality of the depth preprocessing module (230) is to generate a background depth map (732) and a foreground depth map (742).

The depth estimation submodules (710, 720) operate to generate estimated depth maps D (712) and \tilde{D}^{B} (722) corresponding to the input image I (202) and the background image I^{B} (422), respectively. In one example, the depth estimation submodules (710, 720) are implemented using the monocular depth estimation method Metric3D described in the above cited paper by Wei Yin, et al., “Metric3D: Towards Zero-shot Metric 3D Prediction from A Single Image,” Proceedings of the IEEE/CVF International Conference on Computer Vision (ICCV), 2023, because it tends to provide temporally more consistent results than some other methods. However, in other examples, other suitable monocular depth estimation methods can also be used. Nevertheless, in at least some examples, the estimated depth maps (712, 722) may exhibit temporal and spatial inconsistency, which typically causes artifacts in the following MPI reconstruction. The deflickering submodule (730) and the foreground normalization submodule (740) operate to remedy these issues and improve the consistency of depth predictions, e.g., as described in more detail below.

It should be noted that the workflow (700) is presented with one of the most challenging cases for depth estimation, wherein the input video contains no camera pose information and little or no multi-view information. As a result, some conventional depth estimation methods, including those specially developed for monocular videos, tend to have poor temporal consistency for the use cases of interest. We observed that the temporal inconsistency in depth map typically leads to relatively strong flickering in the reconstructed background MPI video. The deflickering submodule (730) is configured to resolve this issue by applying a video deflickering technique to the sequence of the background depth maps (722). In one example, the deflickering submodule (730) is implemented using the Deflicker tool described in Lei, Chenyang, et al., “Blind Video Deflickering by Neural Filtering with a Flawed Atlas,” Proceedings of the IEEE/CVF Conference on Computer Vision and Pattern Recognition (CVPR), 2023, which is incorporated herein by reference in its entirety. In other examples, the deflickering submodule (730) can also be implemented using other suitable deflickering methods. In operation, the deflickering submodule (730) converts the sequence of the estimated background depth maps \tilde{D}^{B} (722) into a corresponding sequence of temporally consistent background depth maps D^{B} (732). The foreground normalization submodule (740) then operates to overwrite the background area of the estimated depth map D (712) with the corresponding stabilized background depth map D^{B} (732), and also using the corresponding segmentation mask (212) as an additional guidance.

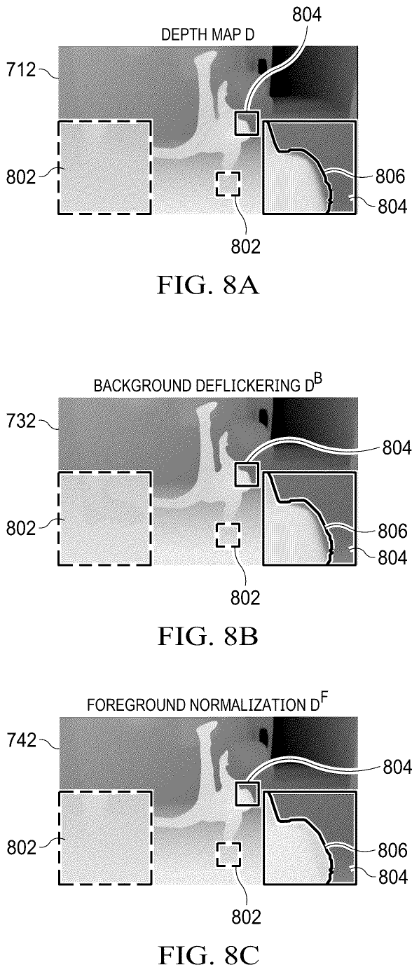

FIGS. 8A-8C pictorially illustrate certain artifacts that can be corrected with the deflickering submodule (730) and the foreground normalization submodule (740) according to some examples. More specifically, FIGS. 8A-8C show the depth maps (712, 732, 742) corresponding to the input image (202) shown in FIG. 2. In FIG. 8A, we observe two kinds of inconsistency between the foreground and background. First, the dancer's hand in a first box (802) is darker (i.e., farther from camera) than the surrounding ground. As a result, the hand will appear sinking into ground in the reconstructed MPI. Second, the depth map (712) near the dancer's head in a second box (804) misaligns its segmentation boundary as marked by a curve (806) in the expanded view of the second box (804). Wrong depth values along the object boundary will typically result in edge artifacts in the reconstructed MPI. The deflickering submodule (730) and the foreground normalization submodule (740) are configured to analyze and resolve these artifacts via two foreground depth normalization techniques described in more detail below. The first of the two techniques is referred to as intersection-aware foreground normalization. The second of the two techniques is referred to as outlier-aware foreground normalization.

We realized that the hand artifact located in the box (802) substantially arises from deficiencies of the upstream methods on the scene consistency. As used herein, the term “scene consistency” means that the depth prediction for the same scene should not be affected by the existence of a particular object. However, the depth prediction for the input image (202) (with the foreground) and the one for the background image (without the foreground) may significantly differ in the background area they share.

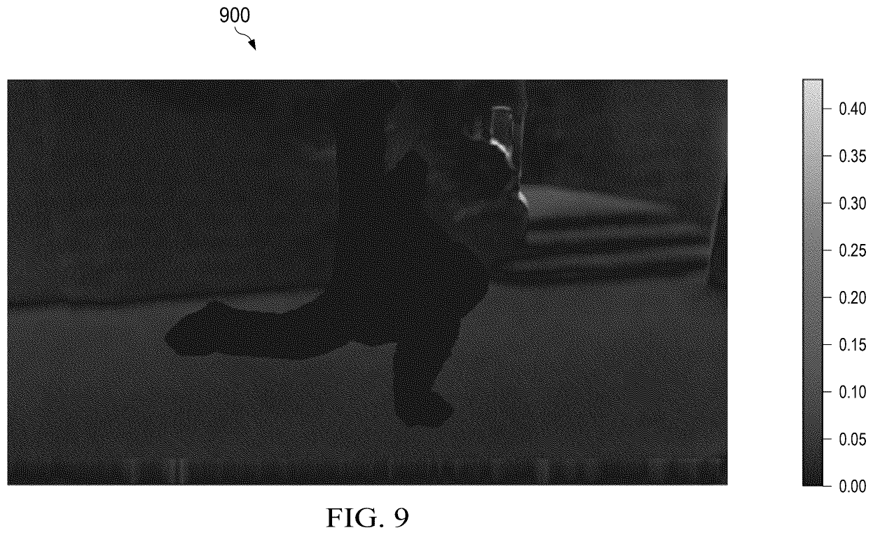

FIG. 9 shows a difference depth map (900) between the estimated depth maps (712, 722) for the examples illustrated in FIGS. 8A-8C. Note that the foreground region is masked in the difference depth map (900). As can be seen from the legend sidebar, given the depth range from 0 to 1, some values in the difference depth map (900) exceed 0.4, which manifests a potential error higher than 40%. In some cases, this difference may be further amplified when the deflickering operation distorts the background depth values to ensure temporal consistency. As a result, the scene inconsistency of this kind may cause visually perceivable artifacts at the intersection area between the foreground and background, such as those in the boxes (802, 804).

To resolve these artifacts, the workflow (700) is configured to make the foreground closely touch the background as they were in D. Towards this end, the workflow (700) is configured to use the foreground depth normalization technique to ensure the consistency at the intersection. A first step of this technique includes locating the pertinent intersection regions. When a foreground pixel belongs to the intersection area, that pixel resides on the object boundary and typically has a similar depth value to its background neighbors. In other words, such a pixel is sufficiently far away from abrupt depth changes, or depth edges. Based on this observation, the foreground normalization submodule (740) is configured to first detect depth edges in the depth map (712) by running an edge detection algorithm over D.

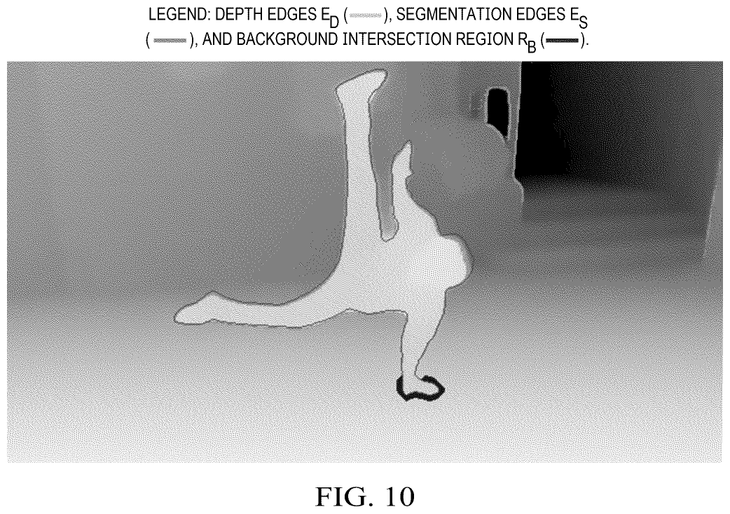

FIG. 10 pictorially illustrates various edges and regions detected with the foreground normalization submodule (740) in the depth map (712) according to some examples. The various edges and regions are marked in FIG. 10 as indicated in the provided legend.

The depth edges can be presented using a binary mask M_{D} {0,1}^{H×W}, and the corresponding pixel coordinates are denoted by E_{D}. Formally, we have:

$${M}_{D} = EdgeDetection ( D ) \qquad ( 12 )$$

$${E}_{D} = \{ {\vec{p}}_{D} = ( x , y ) \vert {M}_{D} [ x , y ] = 1 \} \qquad ( 13 )$$

The depth edges E_{D} computed in this manner are shown in FIG. 10 as indicated in the legend.

The segmentation edges can be presented using the masks M_{S} and E_{S} determined using the input image (202). For example, if we shrink the segmentation mask (212) by one pixel, the disappeared region corresponds to the segmentation edges. As such, the segmentation edges represented by M_{S} and E_{S} can be computed as follows:

$${M}_{S} = M ⊕ Erosion ( M , 1 ) \qquad ( 14 )$$

$${E}_{S} = \{ {\vec{p}}_{S} = ( x , y ) \vert {M}_{S} [ x , y ] = 1 \qquad ( 15 )$$

where ⊕ denotes the logical XOR operation; and Erosion(·, n) is a function that shrinks a binary mask by n pixels. The depth edges E_{S} computed in this manner are shown in FIG. 10 as indicated in the legend.

According to our previous definition, a pixel belongs to the foreground intersection region R_{F} if it belongs to segmentation edges but stays far away from the depth edges. In other words, its distance from the closest pixel on the depth edge is larger than a preset threshold τ. In one example, τ=15 pixels. This property can be formally defined as:

$${R}_{F} = \{ {\vec{p}}_{S} ∈ {E}_{S} \vert {min}_{{\vec{p}}_{D} ∈ {E}_{D}} {‖ {\vec{p}}_{S} , {\vec{p}}_{D} ‖}_{2} > τ \} \qquad ( 16 )$$

Intuitively, the region near R_{F} that exists in the background is the background intersection region R_{B}. To obtain R_{B}, we turn R_{F} into the corresponding binary mask M_{F}, expand it by δ=5 pixels using Dilation(M_{F}, δ), and compute its intersection with the background mask ¬M via the logical AND operation Λ, which can be expressed as follows:

$${M}_{B} = Dilation ( {M}_{F} , δ ) ∧ ¬ M \qquad ( 17 )$$

The binary masks M_{F} and M_{B} can then be used to indicate R_{F} and R_{B}, respectively. The background intersection region R_{B} computed in this manner is shown in FIG. 10 as indicated in the legend. As illustrated by FIG. 10, the above-described algorithm used in the workflow (700) correctly tells that the foreground dancer intersects with the background at the hand region.

The foreground normalization submodule (740) is further configured to compute the average depth values within M_{F} and M_{B} in the estimated depth map D (712). By computing a difference between them, the foreground normalization submodule (740) obtains the distance s between the foreground and background. The value of s is typically small because the foreground closely touches the background at the intersection region R_{B}.

The foreground normalization submodule (740) is further configured to overwrite the background area using the values from the background depth map D^{B} (732). As mentioned above, due to the effects of scene inconsistency, the depth maps D (712) and D^{B}(732) may be inconsistent in the background area. As a result, after the overwriting operation, the new foreground-background distance s′ at the intersection regions may become relatively large. To resolve this issue, the foreground normalization submodule (740) operates to push the foreground until it touches the background. This “pushing” operation can be performed, e.g., by adding an offset s-s′ to the depth values in the foreground area. In this manner, the foreground-background distance changes from s′ back to s. As illustrated by FIG. 8C, the above-described processing implemented in the foreground normalization submodule (740) helps the foreground hand located in the box (802) to have a natural transition to the background.

Algorithm 1 presented below provides a pseudocode that can be used to implement the intersection-aware foreground normalization in the foreground normalization submodule (740) according to one example.

Algorithm 1: Intersection-Aware Foreground Depth Normalization

| | |
|---|---|
| 1: | M_{D} ← EdgeDetection(D) # detect depth edges |
| 2: | E_{D} ← {\vec{p}_{D} = (x, y)\|M_{D}[x, y] = 1} # convert mask to pixel coordinates |
| 3: | M_{S} ← M ⊕ Erosion(M, 1) # compute segmentation edges |
| 4: | E_{S} ← {\vec{p}_{S} = (x, y)\|M_{S}[x, y] = 1} # convert mask to pixel coordinates |
| 5: | R_{F} ← {\vec{p}_{S} ∈ E_{S} \| ∥\vec{p}_{S}, \vec{p}_{D}∥₂ > τ, ∀ \vec{p}_{D} ∈ E_{D}} #foreground intersection region |
| 6: | M_{F} ← {0}^{H×W} # initialize mask |
| 7: | M_{F}[x, y] ← 1, ∀(x, y) ∈ R_{F} # convert pixel coordinates to mask |
| 8: | M_{B} ← Dilation(M_{F}, δ) ∧ ¬M # background intersection region |
| 9: | s ← Mean(D[M_{F}]) − Mean(D[M_{B}]) # original foreground-background distance |
| 10: | D[¬M] ← D_{B}[¬M] # overwrite background area |
| 11: | s′ ← Mean(D[M_{F}]) − Mean(D[M_{B}]) # new foreground-background distance |
| 12: | D[M] ← D[M] + s − s′ # shrift foreground area |
| 13: | return D |

We further realized that the head artifact located in the box (804) in FIG. 8A is substantially caused by a mismatch between the segmentation and depth estimation operations. When the segmentation module (210) and the depth estimation submodules (710, 720) are implemented using respective independently constructed tools (such as different respective off-the-shelf tools utilized in some examples), a misalignment of the corresponding maps may be present, especially at the object boundary. This effect can be seen, e.g., in FIG. 10, where the segmentation edges Eₛ and the depth edges E_{D} do not perfectly overlap. In some examples, this type of misalignment can cause the background depth values to leak into the foreground, ending up with some boundary pixels being stretched to wrong positions. The foreground normalization submodule (740) operates to alleviate this problem by ignoring the far outliers in the foreground depth by applying the outlier-aware foreground normalization.

We define the foreground region with the largest (close to camera) E percent of depth values as valid and indicate them using the mask M_{V} and pixel coordinates R_{V}. Herein, the function Percentile(·, ϵ) returns the value at a given percentage ϵ. In one example, ϵ=95 to remove 5% of the depth values that are far from the camera. The rest of the foreground region is viewed as the outlier region, denoted by M_{O} and Rₒ. We can then fill each outlier pixel with its closest neighbor value from the valid region. As illustrated with FIGS. 8A-8C, this strategy grants more reasonable depth values to the dancer's head in the box (804), thereby improving the quality of reconstructed MPI. At the end of the outlier-aware foreground normalization, the depth map is cropped to generate the final normalized foreground depth map D^{F} (742).

Algorithm 2 presented below provides a pseudocode that can be used to implement the outlier-aware foreground normalization in the foreground normalization submodule (740) according to one example.

Algorithm 2: Outlier-Aware Foreground Depth Normalization

| | |
|---|---|
| 1: | M_{V} ← M ∧ (D > Percentile(D, ϵ)) # compute valid region |
| 2: | R_{V} ← {(x, y)\|M_{V}[x, y] = 1} # convert mask to pixel coordinates |
| 3: | M_{O} ← M ⊕ M_{V} # compute outlier region |
| 4: | R_{O} ← {(x, y)\|M_{O}[x, y] = 1} # convert mask to pixel coordinates |
| 5: | for (x ,y) ∈ R_{O}: |
| 6: | (x*, y*) ← argmin_{(x′,y′)∈R}_{_{V}}∥(x, y), (x′, y′)∥₂ # find closest valid neighbor |
| 7: | D[x, y] ← D[x*, y*] # replace outlier value with valid value |
| 8: | D^{F} ← M ⊙ D # compute foreground depth map |
| 9: | return D^{F} |

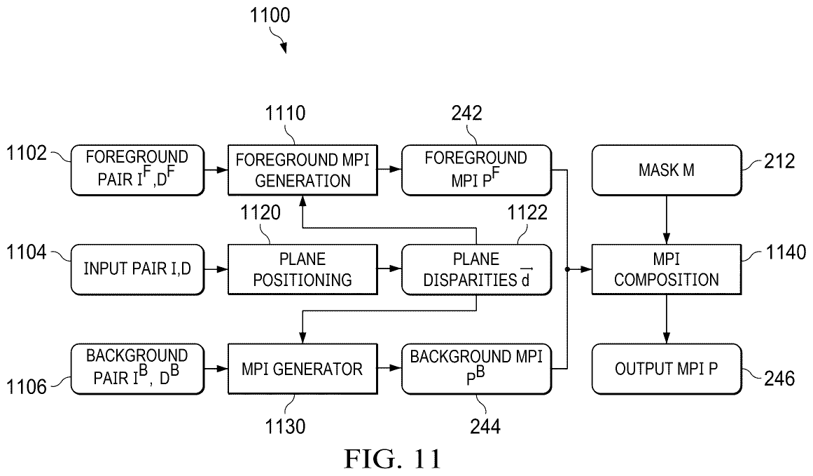

FIG. 11 is a block diagram illustrating a workflow (1100) of the MPI generation module (240) used in the pipeline (200) according to some examples. The MPI generation module (240) includes a foreground MPI generation submodule (1110), a plane positioning submodule (1120), an MPI generator (1130), and an MPI composition submodule (1140). The overall functionality of the MPI generation module (240) is to generate and the foreground MPI (242) and the background MPI (244) and then compose these two MPIs into the output MPI (246).

In one example, the workflow (1100) is configured to use AdaMPI to convert an image-depth pair into an MPI. AdaMPI is described in more detail in the above-cited paper by Han Yuxuan, Ruicheng Wang, and Jiaolong Yang, “Single-view view synthesis in the wild with learned adaptive multiplane images,” ACM SIGGRAPH 2022 Conference Proceedings. The plane positioning submodule (1120) operates to run the Plane Adjustment Network of AdaMPI over an input pair (1104) including the input image I (202) and the corresponding depth map D (712) to determine the MPI plane positions represented by a disparities vector \vec{d} (1122). The workflow (1100) is further configured to reconstruct the foreground MPI (242) and the background MPI (244) according to the same disparities vector \vec{d} (1122) with the same number of planes K, which enables straightforward merging of these two MPIs in the downstream processing. In one example, the number K is set to K=32. In other examples, other suitable K values can similarly be used. The MPI composition submodule (1140) operates to composite the MPIs (242, 244) into the output MPI P (246) using the segmentation mask M (212) as a guide. In other examples, other suitable MPI generators and/or their relevant constituent components can also be used in the workflow (1100).

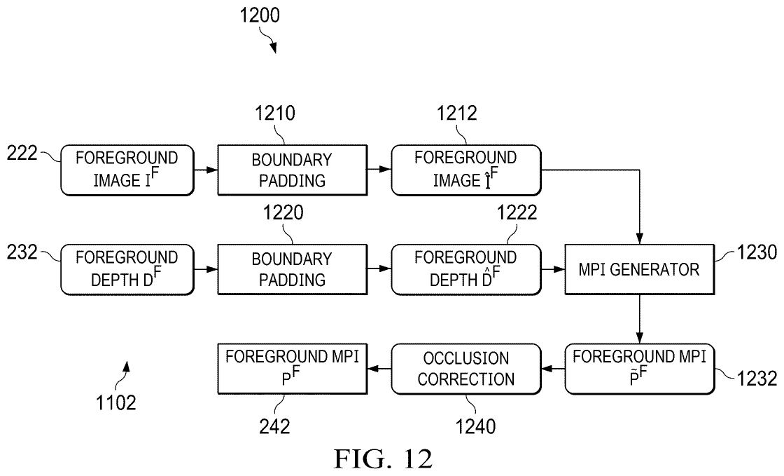

FIG. 12 is a block diagram illustrating a workflow (1200) of the foreground MPI generation submodule (1110) used in the workflow (1100) according to some examples. While it is relatively straightforward to configure the MPI generator (1130) to generate the background MPI (244), the generation of the foreground MPI (244) involves additional preprocessing operations to generate the inputs applied to an instance (1230) of the MPI generator, e.g., running the AdaMPI tool for the workflow (1200). The preprocessing operations are implemented using boundary padding submodules (1210, 1220). The workflow (1200) also includes post-processing operations applied to the output of the MPI generator (1230). The post-processing operations are implemented using an occlusion correction submodule (1240).

In some examples, if we directly generate the MPI using a foreground image-depth pair (1102), we may find background colors leaking into the edge of the foreground. This effect occurs, e.g., because AdaMPI utilizes convolutional layers to extract deep learning features from local pixels. In some cases, such utilization mistakenly brings background information into the foreground. To prevent this effect, the workflow (1100) uses the boundary padding submodules (1210, 1220) configured to outward pad the foreground object's boundary in the foreground image I^{F} (222) and the foreground depth map D^{F} (232) of the pair (1102). In one example, the boundary is expanded by 10 pixels, and the newly added region is filled with pixels from the closest boundary. In other examples, other expansion width can also be used. This padding expansion beneficially prevents the color leakage because the AdaMPI convolutions of the MPI generator (1230) can now only access values from the foreground.

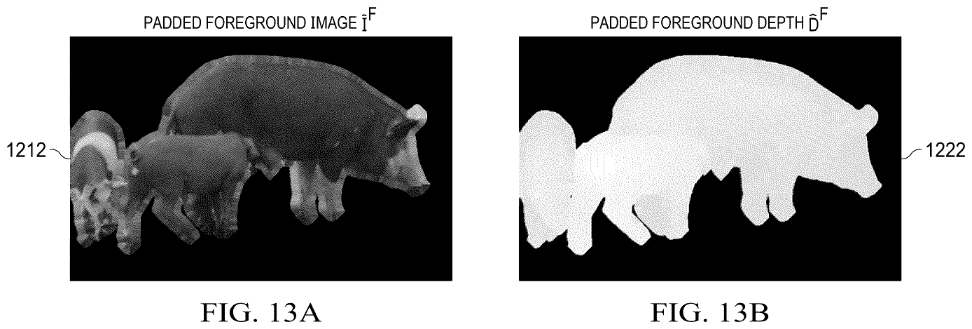

FIGS. 13A-13B pictorially illustrate a padded foreground image Î^{F} (1212) and a padded depth map \hat{D}^{F} (1222) generated by the boundary padding submodules (1210, 1220) according to some examples. The padded foreground image Î^{F} (1212) and the padded depth map \hat{D}^{F} (1222) are fed into the MPI generator (1230), e.g., running the AdaMPI, which produces a foreground MPI \tilde{P}^{F} (1232). The foreground objects in the MPI (1232) are larger than they should be, which is corrected in the downstream processing by cropping the foreground object back to their normal (unpadded) sizes.

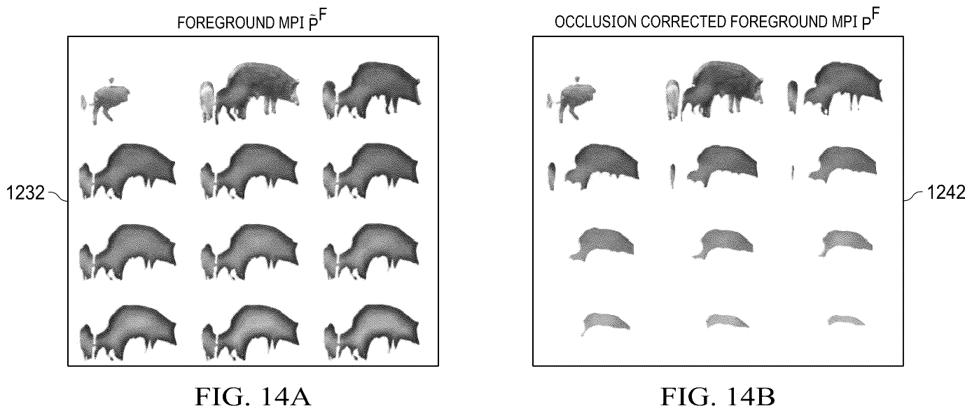

FIGS. 14A-14B pictorially illustrate operations of the occlusion correction submodule (1240) used in the workflow (1200) according to some examples. More specifically, FIG. 14A pictorially illustrates selected twelve planes of the foreground MPI \tilde{P}^{F}(1232), which are presented in a zigzag order. FIG. 14B similarly pictorially illustrates the corresponding twelve planes of the foreground MPI P^{F} (242) generated in the occlusion correction submodule (1240) by processing the foreground MPI \tilde{P}^{F} (1232) of FIG. 14A.

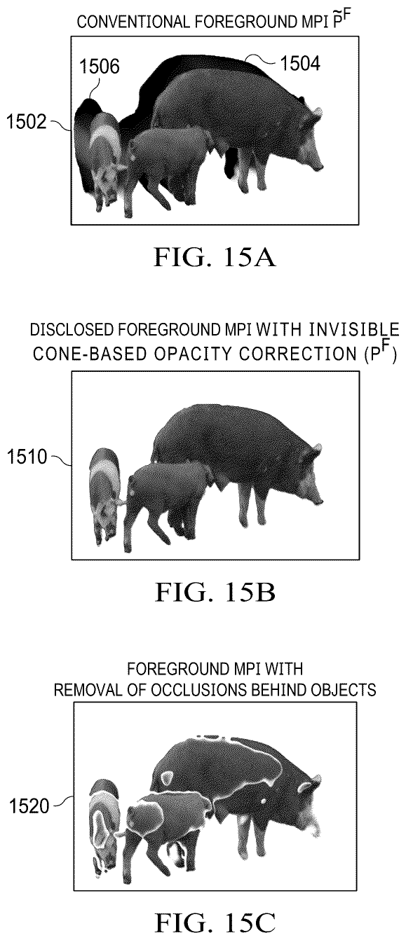

FIGS. 15A-15C further pictorially illustrate operations of the occlusion correction submodule (1240) used in the workflow (1200) according to some examples. It should be noted that the task of merging the foreground MPI into the background MPI does not lend itself to a straightforward implementation. For example, AdaMPI tends to inpaint the occluded region with blurry colors by creating solid occlusions behind the foreground object. An example of this behavior is pictorially illustrated in FIG. 14A. Therein, one can see occlusions having the same shape as the foreground objects (pigs), connecting those objects all the way to the background.

FIG. 15A illustrates an image (1502) rendered at a new camera pose using the foreground MPI \tilde{P}^{F} (1232) from FIG. 14A. The above-mentioned solid occlusions in the MPI (1232) manifest themselves as shadow artifacts (1504, 1506) in the rendered image (1502). One straightforwardly implementable solution is to keep the object's foremost surface and remove all occlusions behind the object. However, such occlusion removal disadvantageously causes layer-breaking artifacts pictorially illustrated by a corresponding rendered image (1520) shown in FIG. 15C. These artifacts likely appear at MPI rendering because the MPI uses occlusions to fill the gap between the adjacent planes when rendering from a novel view. In contrast, embodiments of the occlusion correction submodule (1240) implement an occlusion correction scheme that can beneficially eliminate shadow artifacts in the background while ensuring the integrity of foreground, e.g., as illustrated by an image (1510) shown in FIG. 15B, which is obtained by rendering the occlusion corrected MPI (242) (also see FIG. 14B).

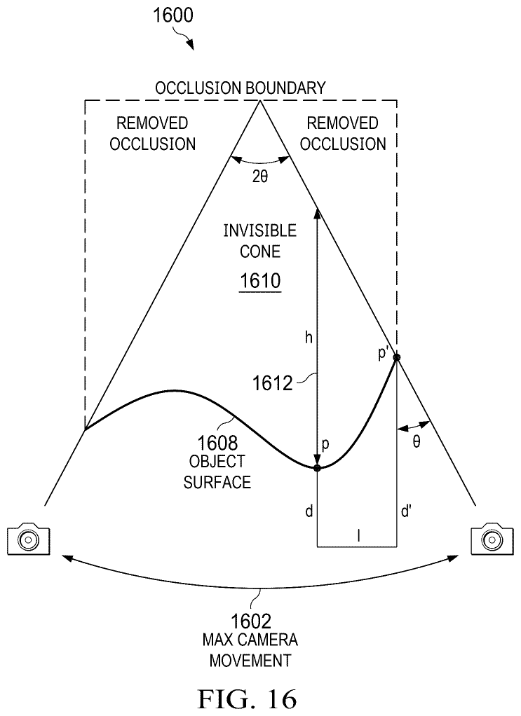

FIG. 16 is a schematic diagram illustrating an occlusion correction scheme (1600) implemented in the occlusion correction submodule (1240) according to some examples. The occlusion correction scheme (1600) beneficially leverages the innate nature of MPI as being a set of fronto-parallel planes. Since the MPI is composed of fronto-parallel planes, the MPI has a maximum viewing angle θ that is smaller than 90°. As indicated in FIG. 16, a laterally limited camera movement (1602) leads to the presence of an invisible cone (1610) behind an object surface (1608). The contents within the invisible cone (1610) will not be rendered provided that the novel camera pose stays within the limits (1602). In contrast, at least some contents outside the invisible cone (1610) can be rendered for some camera poses within the limits (1602). Therefore, the occlusion correction scheme (1600) is configured to delete the occlusions outside the invisible cone (1610), thereby substantially removing shadow artifacts, such as the shadow artifacts (1504, 1506) illustrated in FIG. 15A. The occlusion correction scheme (1600) is further configured to retain the occlusions inside the invisible cone (1610), thereby substantially preventing the layer-breaking artifacts illustrated in FIG. 15C.

Using the above-described geometric structure of MPI, can analytically and efficiently compute the shape of the invisible cone (1610). Despite the MPI generator being able to position the planes differently (e.g., non-equidistantly), we initially assume that all MPI planes are evenly spaced with the constant distance Δ therebetween. In some examples, one can use an object surface matrix

$$S ∈ {ℤ}_{+}^{( H , W )}$$

to indicate the position of the object surface (1608). More specifically, given a position p=(x, y), the expression S[x, y]=kₚ means that the object surface (1608) at this position p is located at the kₚ-th plane of the MPI, and that the surface has a depth d=kₚ·Δ from camera. While the MPI does not have a continuous curved surface, we can assume that the location where the accumulated alpha first reaches a threshold γ=0.99 is the location of the surface. Then, finding the invisible cone (1610) is equivalent to computing the length of h (1612) for every point on the object surface (1608). To compute the value of h (1612), we need to pick a point p′=(x′, y′) ∈E_{S} from the object boundary, where E_{S} is the segmentation edge that was already computed in the upstream processing of the pipeline (200). We denote the L2 distance between two points using l=∥p,p′∥₂. In addition, we have S[x′, y′]=d′. Then according to the geometry illustrated in FIG. 16, h can be computed using the following:

$$h + d = {d}^{′} + cot θ \cdot l \qquad ( 18 )$$

We define the conic surface matrix

$${S}_{C} ∈ {ℤ}_{+}^{( H , W )}$$

to store the position of the invisible cone (1610). The expression S_{C}[p]=k_{c} means that the invisible cone (1610) is at position p at the plane indexed by k_{c}. In one example, k_{c} can be computed as follows:

$${k}_{c} Δ = h + ⌊ d ⌋ = {k}_{{p}^{′}} Δ + ⌊ cot θ \cdot l ⌋ \qquad ( 19 )$$

$$⇒ {k}_{c} = {k}_{{p}^{′}} + ⌊ \frac{cot θ}{Δ} \cdot l ⌋ \qquad ( 20 )$$

Herein, the term

$$\frac{cot θ}{Δ}$$

is set as a hyper-parameter based on the rendering camera position and resolution. For each p, we want to eliminate all possible artifacts by computing the lowest k_{c}, which corresponds to the shortest h+d. We can find this minimum value, denoted as

$${k}_{c}^{*} ,$$

by traversing all boundary points. In summary, we have:

$${k}_{c}^{*} = {min}_{{p}^{′} ∈ {S}_{B}} {k}_{{p}^{′}} + ⌊ \frac{cot θ}{Δ} \cdot {‖ p , {p}^{′} ‖}_{2} ⌋ \qquad ( 21 )$$

In one example, the occlusion correction submodule (1240) is configured to compute a multi-plane binary mask M_{C}∈{0,1}^{(K,H,W)} from S_{C} to mask regions beyond the invisible cone (1610). More specifically, for every plane index k, M_{C}[k] is a binary mask indicating the cross section of the invisible cone (1610). Thereafter, the occlusion correction submodule (1240) operates to remove redundant occlusions by applying the multi-plane binary mask M_{C} to the foreground MPI planes. As can be seen in FIG. 14B, this application of the mask M_{C} causes the occlusion correction to gradually shrink the object in the MPI planes in accordance with the invisible cone (1610), thereby forcing the object to have a conically shaped back in the MPI stack. The image (1510) shown in FIG. 15B provides an example result of rendering the clean foreground MPI P^{F} (242) obtained with the occlusion correction submodule (1240) implementing the occlusion correction scheme (1600). Visual results presented in FIGS. 15A-15C clearly demonstrate that the workflow (1200) is beneficially capable of substantially eliminating both the shadow and layer-breaking artifacts.

Referring back to FIG. 11, the MPI composition submodule (1140) operates to merge the foreground MPI P^{F} (242) and the background MPI P^{B} (244) to form the output MPI P (246). With a safe assumption that the foreground objects are in front of the background, we know that the foreground content dominates inside the invisible cone (1610), whereas the background dominates outside the invisible cone (1610). In addition, the foreground MPI (242) and the background MPI (244) share the same plane positions, as the workflow (1100) is configured to condition those MPIs based on the same (common) disparities vector d (1122). Therefore, to fuse MPIs (242, 244), the MPI composition submodule (1140) only needs to overwrite the foreground MPI plane P^{F}[k] upon the background MPI plane P^{B}[k] according to the conic mask M_{C}[k] for every plane index k. In one example, the MPI composition submodule (1140) performs this operation in a batch to obtain to obtain the MPI (246) as follows:

$$P = {M}_{c} ⊙ {P}^{F} + ¬ {M}_{c} ⊙ {P}^{B} \qquad ( 22 )$$

Algorithm 3 presented below provides a pseudocode that can be used to implement the functionalities of the occlusion correction submodule (1240) and the MPI composition submodule (1140) according to one example.

```
Algorithm 3: Occlusion Correction and MPI Composition
  1: A ← CumSum(P^{F}[:, 3 ], 0) > γ   # whether accumulated alpha reaches threshold
  2: S ← {0}^{(H,W)}  # initialize object surface matrix
  3: for k ∈ [0, ... , K − 2]:
  4: S[A[k] ∧ ¬ A[k + 1]] ← k + 1  # detect object surface
  5: S_{C} ← {0}^{(H,W)}  # initialize conic surface matrix
  $6 : {S}_{C} [ ( x , y ) ] ← {k}_{c}^{*} , ∀ x , y \# computed from Eq . 4.12$
  7: S_{C} ← Max(S_{C}, S)  # remain surface points
  8: M_{C} ← {0}^{(K,H,W)}  # initialize conic mask
  9: for k ∈ [0, ... , K − 1]:
10: M_{C}[k] ← M∧ (k ≤ S) # compute conic mask
11: M_{C}[k] ← Guassian Blur(Median Blur(M_{C}[k])) # soften conic mask
12: P ← M_{C} ⊙ P^{F} + ¬ M_{C}[k] ⊙ P^{B} # composite MPI
13: return P
```

In line 1 of Algorithm 3, the function CumSum(·,0) accumulatively sums over dimension 0; and A is a binary mask indicating whether the accumulated alpha exceeds threshold γ. In line 7, we choose the larger value between S_{C} and S for every position to prevent removing a meaningful surface point. In line 12, we ignore the step to remove occlusions in foreground MPI. It is mathematically similar to directly merging the foreground MPI and the background MPI according to the conic mask M_{C}.

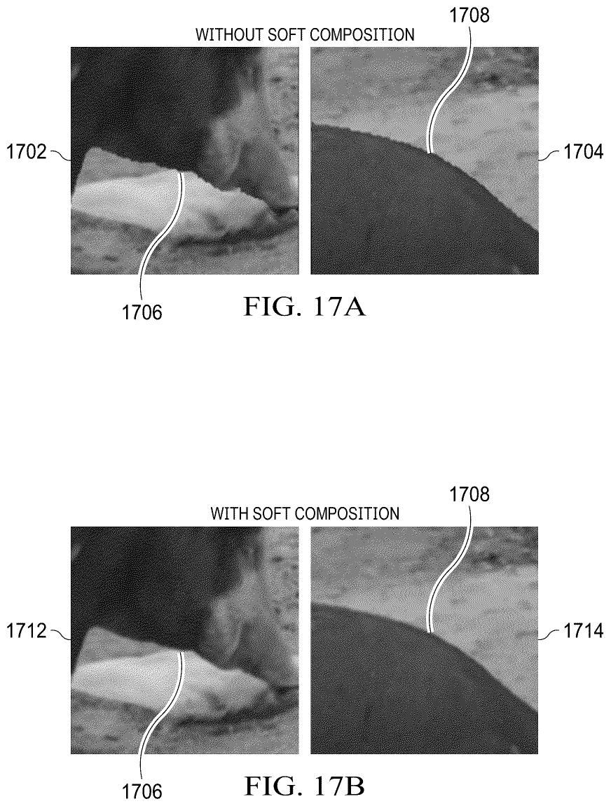

FIGS. 17A-17B pictorially illustrate effects of soft MPI composition used in the MPI composition submodule (1140) according to some examples. More specifically, FIG. 17A shows portions (1702, 1704) of an image obtained by rendering the MPI assembled directly using the conic mask M_{C}. In the portions (1702, 1704), boundaries (1706, 1708) of the foreground object (pig) look sharp and serrated because the conic mask M_{C} is a binary mask. This property of the mask results in an abrupt transition between the foreground and background, while also incurring edge flickering artifacts across multiple video frames. To mitigate these deleterious effects, the MPI composition submodule (1140) may be configured to use a soft MPI composition scheme in at least some embodiments. In one example, soft MPI composition scheme includes: (i) applying Median blur to the conic mask M_{C} to melt its boundary, and (ii) applying Gaussian blur to soften the edges. These operations are represented by line 11 in the above-shown Algorithm 3. FIG. 17A shows portions (1712, 1714) of an image obtained by rendering the MPI assembled using the “softened” conic mask M_{C} obtained via these blur operations. A side-by-side comparison of the boundaries (1706, 1708) in FIGS. 17A and 17B clearly illustrates that the soft MPI composition scheme is capable of improving the visual quality of the rendered images by naturally blending the foreground and background.

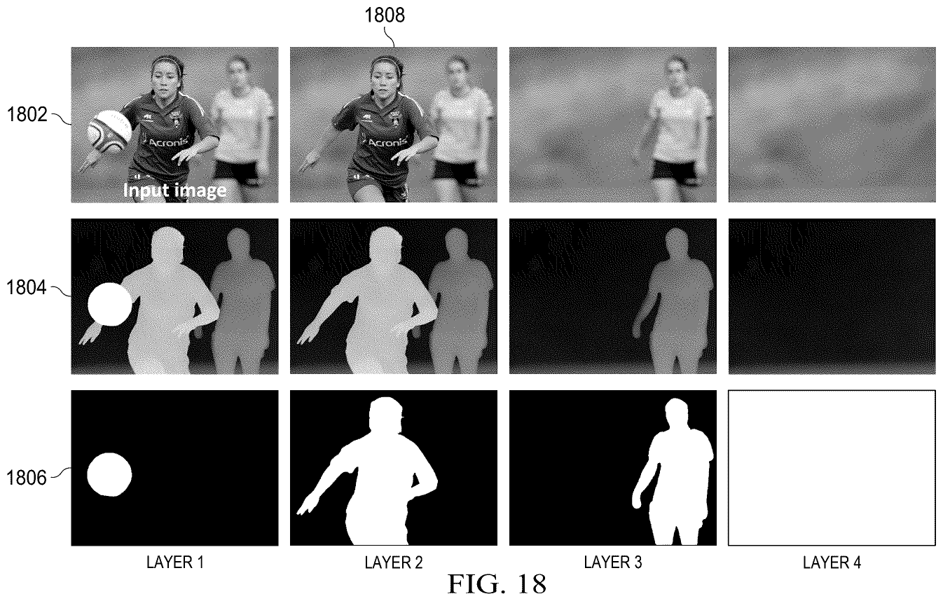

FIG. 18 pictorially illustrates a modification of the pipeline (200) to provide for multilayer (>2) scene reconstruction according to some examples. For illustration purposes and without any implied limitations, the pipeline (200) has been described above in reference to two-layer reconstruction, i.e., using the foreground and background layers. However, for some contents, multilayer (>2) scene reconstruction may be more appropriate. The above-described methods used in the pipeline (200) lend themselves to relatively straightforward generalization to a larger-than-two number of layers, e.g., by iteratively peeling off the foremost layer as the foreground.

An example modification corresponding to four layers is pictorially illustrated in FIG. 18. Given an input image (1802), the modified pipeline operates to estimate a corresponding depth map 1804. In the example shown, the ball is specified to belong to the foreground layer 1 by generating a layer 1 mask 1806. The modified pipeline then operates to reconstruct an MPI for the ball by conducting the image preprocessing, depth preprocessing, and foreground MPI generation blocks as described above. After these blocks, an inpainted image (1808) without the ball is obtained and is used as the input image to the second iteration. Additional iterations are performed to generate MPI for the near person (layer 2), the far person (layer 3), and finally the background (layer 4). Modifications to the MPI composition module (1140) enable that module to compose the output MPI (246) from the four MPIs corresponding to the layers 1-4.

Another example modification can be used to enable the resulting modified pipeline (200) to process monocular images (rather than monocular videos). Toward this end result, the following modifications can be made. First, in the image preprocessing module (220), we only perform peeling and generative inpainting. Correlative inpainting is no longer performed therein because no temporal correlation can be exploited. In the depth preprocessing module (230), we adopt the Marigold tool for depth estimation. The Marigold tool is described in detail, e.g., in Bingxin Ke, et al., “Repurposing Diffusion-Based Image Generators for Monocular Depth Estimation,” Proceedings of the IEEE/CVF Conference on Computer Vision and Pattern Recognition (CVPR), 2024, which is incorporated herein by reference in its entirety. In at least some examples, the Marigold tool depth estimation tool may be more suitable for processing monocular images, e.g., because it typically produces finer details compared with the Metric3D tool. Additionally, the background deflickering step is omitted in this modified pipeline.

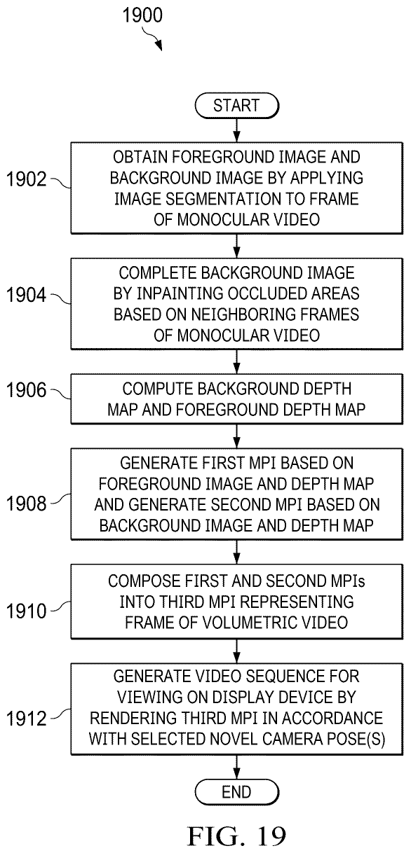

FIG. 19 is flowchart illustrating a method (1900) of generating a volumetric video based on a monocular video according to some examples. In some examples, the method (1900) can be used to implement the pipeline (200).

A block (1902) of the method (1900) includes obtaining a respective foreground image and a respective background image based on image segmentation of a frame of the monocular video. In one example, operations of the block (1902) are implemented using the segmentation module (210) and the image processing module (220). In some examples, the image segmentation is implemented using a vision transformer or a convolutional neural network (CNN). In some examples, the image segmentation is implemented based on one or more spatial indicator inputs marking one or more foreground objects in the frame of the monocular video. The one or more spatial indicator inputs may be selected from the group consisting of a user click on a foreground object, a bounding box generated via automated object detection, and a text prompt.

A block (1904) of the method (1900) includes completing the respective background image by inpainting one or more occluded areas therein based on one or more neighboring frames of the monocular video. In one example, operations of the block (1904) are implemented using the image processing module (220). In some examples, operations of the block (1904) include: (i) estimating an optical flow based on a sequence of frames of the monocular video, the sequence including the frame of the of the monocular video and the one or more neighboring frames; (ii) applying correlative inpainting to the respective background image based on the estimated optical flow and further based on the sequence of frames; and (iii) applying generative inpainting to a partially inpainted image obtained with the correlative inpainting. In some examples, the generative inpainting is also based on the estimated optical flow. In some examples, operations of the block (1904) further include performing two or more iterations directed at obtaining temporal consistency among inpainted background images corresponding to the sequence of frames, each of the iterations including a respective occurrence of the correlative inpainting and a respective occurrence of the generative inpainting.

A block (1906) of the method (1900) includes computing a background depth map corresponding to the completed background image and a foreground depth map corresponding to the respective foreground image. In one example, operations of the block (1906) are implemented using the depth processing module (230). In some examples, computing the background depth map comprises stabilizing the background depth map by applying video deflickering to a sequence of background depth maps corresponding to a sequence of frames of the monocular video, the sequence including the frame and one or more neighboring frames of the monocular video. Computing the foreground depth map comprises: (i) computing an estimated depth map of a full image contained in the frame; (ii) replacing an outlier pixel value in the estimated depth map with a pixel value from a nearest valid pixel; and (iii) overwriting a background area of the estimated depth map with the stabilized background depth map to obtain a normalized depth map.

A block (1908) of the method (1900) includes generating a first MPI based on the respective foreground image and the foreground depth map and generating a second MPI based on the completed background image and the background depth map. In one example, operations of the block (1908) are implemented using the MPI generation module (240). In some examples, operations of the block (1908) include computing an estimated depth map of a full image contained in the frame and determining a disparities vector \vec{d} based on the full image and the estimated depth map. Each of the first and second MPIs has the same MPI plane positions determined based on the disparities vector \vec{d}.

In some examples, operations directed at generating the first MPI in the block (1908) include: (i) padding a boundary of a foreground object in the respective foreground image to obtain a padded foreground image; (ii) padding the boundary of the foreground object in the foreground depth map to obtain a padded foreground depth map; (iii) generating a preliminary foreground MPI based on the padded foreground image and the padded foreground depth map; and (iv) performing occlusion correction in the preliminary foreground MPI to generate the first MPI. In some examples, performing the occlusion correction comprises deleting redundant occlusions in the preliminary foreground MPI located outside a conic shape defined by a maximum range of camera movement allowed for MPI rendering and further defined by a geometric shape of the fireground object. The deleting is performed based on a multi-plane binary mask representing the conic shape in the preliminary foreground MPI.

A block (1910) of the method (1900) includes composing the first and second MPIs into a third MPI representing a frame of the volumetric video corresponding to the frame of the monocular video. In one example, operations of the block (1910) are implemented using the MPI generation module (240). In some examples, the composing includes overwriting contents of the first MPI with contents of the second MPI using the multi-plane binary mask. In some examples, operations of the block (1910) include applying a first (e.g., Median) blur to a boundary of the multi-plane binary mask and applying a second (e.g., Gaussian) blur to an edge of the multi-plane binary mask.

A block (1912) of the method (1900) includes generating a video sequence for viewing on a display device by rendering the third MPI in accordance with a selected novel camera pose. In various examples, the selection of the novel camera pose may be restricted by the lateral limits (1602).

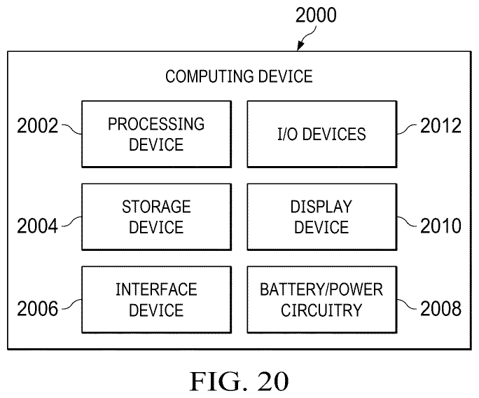

FIG. 20 is a block diagram of an example computing device (2000), one or more instances of which can be used to implement various pipelines, workflows, and methods according to some examples. The computing device (2000) of FIG. 20 is illustrated as having a number of components, but any one or more of these components may be omitted or duplicated, as suitable for the application and setting. In some embodiments, some or all of the components included in the computing device (2000) may be attached to one or more motherboards and enclosed in a housing. In some embodiments, some of those components may be fabricated onto a single system-on-a-chip (SoC) (e.g., the SoC may include one or more electronic processing devices (2002) and one or more storage devices (2004)). Additionally, in various embodiments, the computing device (2000) may not include one or more of the components illustrated in FIG. 20, but may include interface circuitry for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device (2000) may not include a display device (2010), but may include display device interface circuitry (e.g., a connector and driver circuitry) to which an external display device (2010) may be coupled.

The computing device (2000) includes a processing device (2002) (e.g., one or more processing devices). As used herein, the terms “electronic processor device” and “processing device” interchangeably refer to any device or portion of a device that processes electronic data from registers and/or memory to transform that electronic data into other electronic data that may be stored in registers and/or memory. In various embodiments, the processing device (2002) may include one or more digital signal processors (DSPs), application-specific integrated circuits (ASICs), central processing units (CPUs), graphics processing units (GPUs), server processors, or any other suitable processing devices.

The computing device (2000) also includes a storage device (2004) (e.g., one or more storage devices). In various embodiments, the storage device (2004) may include one or more memory devices, such as random-access memory (RAM) devices (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device (2004) may include memory that shares a die with the processing device (2002). In such an embodiment, the memory may be used as cache memory and include embedded dynamic random-access memory (eDRAM) or spin transfer torque magnetic random-access memory (STT-MRAM), for example. In some embodiments, the storage device (2004) may include non-transitory computer readable media having instructions thereon that, when executed by one or more processing devices (e.g., the processing device (2002)), cause the computing device (2000) to perform any appropriate ones of the methods disclosed herein below or portions of such methods.

The computing device (2000) further includes an interface device (2006) (e.g., one or more interface devices (2006)). In various embodiments, the interface device (2006) may include one or more communication chips, connectors, and/or other hardware and software to govern communications between the computing device (2000) and other computing devices. For example, the interface device (2006) may include circuitry for managing wireless communications for the transfer of data to and from the computing device (2000). The term “wireless” and its derivatives may be used to describe circuits, devices, systems, methods, techniques, communications channels, etc., that may communicate data via modulated electromagnetic radiation through a nonsolid medium. The term does not imply that the associated devices do not contain any wires, although in some embodiments they might not. Circuitry included in the interface device (2006) for managing wireless communications may implement any of a number of wireless standards or protocols, including but not limited to Institute for Electrical and Electronic Engineers (IEEE) standards including Wi-Fi (IEEE 802.11 family), IEEE 802.16 standards, Long-Term Evolution (LTE) project along with any amendments, updates, and/or revisions (e.g., advanced LTE project, ultramobile broadband (UMB) project (also referred to as “3GPP2”), etc.). In some embodiments, circuitry included in the interface device (2006 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device (2006 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device (2006 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device (2006 may include one or more antennas (e.g., one or more antenna arrays) configured to receive and/or transmit wireless signals.

In some embodiments, the interface device (2006) may include circuitry for managing wired communications, such as electrical, optical, or any other suitable communication protocols. For example, the interface device (2006) may include circuitry to support communications in accordance with Ethernet technologies. In some embodiments, the interface device (2006) may support both wireless and wired communication, and/or may support multiple wired communication protocols and/or multiple wireless communication protocols. For example, a first set of circuitry of the interface device (2006) may be dedicated to shorter-range wireless communications such as Wi-Fi or Bluetooth, and a second set of circuitry of the interface device (2006) may be dedicated to longer-range wireless communications such as global positioning system (GPS), EDGE, GPRS, CDMA, WiMAX, LTE, EV-DO, or others. In some other embodiments, a first set of circuitry of the interface device (2006) may be dedicated to wireless communications, and a second set of circuitry of the interface device (2006) may be dedicated to wired communications.

The computing device (2000) also includes battery/power circuitry (2008). In various embodiments, the battery/power circuitry (2008) may include one or more energy storage devices (e.g., batteries or capacitors) and/or circuitry for coupling components of the computing device (2000) to an energy source separate from the computing device (2000) (e.g., to AC line power).

The computing device (2000) also includes a display device (2010) (e.g., one or multiple individual display devices). In various embodiments, the display device (2010) may include any visual indicators, such as a heads-up display, a computer monitor, a projector, a touchscreen display, a liquid crystal display (LCD), a light-emitting diode display, or a flat panel display.

The computing device (2000) also includes additional input/output (I/O) devices (2012). In various embodiments, the I/O devices (2012) may include one or more data/signal transfer interfaces, audio I/O devices (e.g., microphones or microphone arrays, speakers, headsets, earbuds, alarms, etc.), audio codecs, video codecs, printers, sensors (e.g., thermocouples or other temperature sensors, humidity sensors, pressure sensors, vibration sensors, etc.), image capture devices (e.g., one or more cameras), human interface devices (e.g., keyboards, cursor control devices, such as a mouse, a stylus, a trackball, or a touchpad), etc.

Depending on the specific embodiment, various components of the interface devices (2006) and/or I/O devices (2012) can be configured to output suitable control signals, receive suitable control/telemetry signals, and receive and transmit data streams. In some examples, the interface devices (2006) and/or I/O devices (2012) include one or more analog-to-digital converters (ADCs) for transforming received analog signals into a digital form suitable for operations performed by the processing device (2002) and/or the storage device (2004). In some additional examples, the interface devices (2006) and/or I/O devices (2012) include one or more digital-to-analog converters (DACs) for transforming digital signals provided by the processing device (2002) and/or the storage device (2004) into an analog form suitable for being transmitted through a communication channel.

According to an example embodiment disclosed above, e.g., in the summary section and/or in reference to any one or any combination of some or all of FIGS. 1-20, provided is an apparatus for generating a volumetric video based on a monocular video, the apparatus comprising: at least one processor; and at least one memory including program code, wherein the at least one memory and the program code are configured to, with the at least one processor, cause the apparatus at least to: obtain a respective foreground image and a respective background image based on image segmentation of a frame of the monocular video; complete the respective background image by inpainting one or more occluded areas therein based on one or more neighboring frames of the monocular video; compute a background depth map corresponding to the completed background image and a foreground depth map corresponding to the respective foreground image; generate a first multiplane image (MPI) based on the respective foreground image and the foreground depth map; generate a second MPI based on the completed background image and the background depth map; and compose the first and second MPIs into a third MPI representing a frame of the volumetric video corresponding to the frame of the monocular video.

According to another example embodiment disclosed above, e.g., in the summary section and/or in reference to any one or any combination of some or all of FIGS. 1-20, provided is an apparatus for generating a volumetric video based on a monocular video, the apparatus comprising: at least one processor; and at least one memory including program code, wherein the at least one memory and the program code are configured to, with the at least one processor, cause the apparatus at least to: iteratively obtain a plurality of layers representing a frame of the monocular video, the plurality of layers including at least three layers corresponding to different respective nonoverlapping depth ranges, wherein each iteration comprises: obtaining a respective foreground image and a respective background image based on image segmentation of a respective iteration-input image; and completing the respective background image by inpainting one or more occluded areas therein based on one or more neighboring frames of the monocular video; wherein the frame of the monocular video is used as the respective iteration-input image for an initial iteration; wherein the completed respective background image of a preceding iteration is used as the respective iteration-input image for a following iteration, and wherein the at least one memory and the program code are configured to, with the at least one processor, cause the apparatus at least to: for each iteration, generate a respective multiplane image (MPI) based on the respective foreground image obtained in the iteration; for a last iteration, generate an additional MPI based on the completed respective background image of the last iteration; and compose the respective MPIs and the additional MPI into an output MPI representing a frame of the volumetric video corresponding to the frame of the monocular video.

According to yet another example embodiment disclosed above, e.g., in the summary section and/or in reference to any one or any combination of some or all of FIGS. 1-20, provided is a method of generating a volumetric video based on a monocular video, the method comprising: obtaining a respective foreground image and a respective background image based on image segmentation of a frame of the monocular video; completing the respective background image by inpainting one or more occluded areas therein based on one or more neighboring frames of the monocular video; computing a background depth map corresponding to the completed background image and a foreground depth map corresponding to the respective foreground image; generating a first multiplane image (MPI) based on the respective foreground image and the foreground depth map; generating a second MPI based on the completed background image and the background depth map; and composing the first and second MPIs into a third MPI representing a frame of the volumetric video corresponding to the frame of the monocular video.

In some embodiments of the above method, the image segmentation is implemented using a vision transformer or a convolutional neural network (CNN).

In some embodiments of any of the above methods, the image segmentation is implemented based on one or more spatial indicator inputs marking one or more foreground objects in the frame of the monocular video.

In some embodiments of any of the above methods, the one or more spatial indicator inputs are selected from the group consisting of a user click on a foreground object, a bounding box generated via automated object detection, and a text prompt.

In some embodiments of any of the above methods, the completing comprises: estimating an optical flow based on a sequence of frames of the monocular video, the sequence including the frame of the of the monocular video and the one or more neighboring frames; and applying correlative inpainting to the respective background image based on the estimated optical flow and further based on the sequence of frames.

In some embodiments of any of the above methods, the completing further comprises applying generative inpainting to a partially inpainted image obtained with the correlative inpainting.

In some embodiments of any of the above methods, the generative inpainting is based on the estimated optical flow.

In some embodiments of any of the above methods, the completing further comprises performing two or more iterations directed at obtaining temporal consistency among inpainted background images corresponding to the sequence of frames, each of the iterations including a respective occurrence of the correlative inpainting and a respective occurrence of the generative inpainting.

In some embodiments of any of the above methods, computing the background depth map comprises stabilizing the background depth map by applying video deflickering to a sequence of background depth maps corresponding to a sequence of frames of the monocular video, the sequence including the frame and one or more neighboring frames of the monocular video.

In some embodiments of any of the above methods, computing the foreground depth map comprises: computing an estimated depth map of a full image contained in the frame; replacing an outlier pixel value in the estimated depth map with a pixel value from a nearest valid pixel; overwriting a background area of the estimated depth map with the stabilized background depth map to obtain a normalized depth map; and applying a segmentation mask to the normalized depth map to obtain the foreground depth map.

In some embodiments of any of the above methods, the method further comprises: computing an estimated depth map of a full image contained in the frame; and determining a disparities vector \vec{d} based on the full image and the estimated depth map, wherein each of the first and second MPIs has same MPI plane positions determined based on the disparities vector \vec{d}.

In some embodiments of any of the above methods, generating the first MPI comprises: padding a boundary of a foreground object in the respective foreground image to obtain a padded foreground image; padding the boundary of the foreground object in the foreground depth map to obtain a padded foreground depth map; and generating a preliminary foreground MPI based on the padded foreground image and the padded foreground depth map.

In some embodiments of any of the above methods, generating the first MPI further comprises performing occlusion correction in the preliminary foreground MPI to generate the first MPI.

In some embodiments of any of the above methods, performing the occlusion correction comprises deleting redundant occlusions in the preliminary foreground MPI located outside a conic shape defined by a maximum range of camera movement allowed for MPI rendering and further defined by a geometric shape of the fireground object.

In some embodiments of any of the above methods, the deleting is performed based on a multi-plane binary mask representing the conic shape in the preliminary foreground MPI.

In some embodiments of any of the above methods, the composing comprises overwriting contents of the first MPI with contents of the second MPI using the multi-plane binary mask.

In some embodiments of any of the above methods, the composing further comprises: applying a first blur to a boundary of the multi-plane binary mask; and applying a second blur to an edge of the multi-plane binary mask.

In some embodiments of any of the above methods, the method further comprises generating a video sequence for viewing on a display device by rendering the third MPI in accordance with a selected novel camera pose.

According to yet another example embodiment disclosed above, e.g., in the summary section and/or in reference to any one or any combination of some or all of FIGS. 1-20, provided is a method of generating a volumetric video based on a monocular video, the method comprising: iteratively obtaining a plurality of layers representing a frame of the monocular video, the plurality of layers including at least three layers corresponding to different respective nonoverlapping depth ranges, wherein each iteration comprises: obtaining a respective foreground image and a respective background image based on image segmentation of a respective iteration-input image; and completing the respective background image by inpainting one or more occluded areas therein based on one or more neighboring frames of the monocular video; wherein the frame of the monocular video is used as the respective iteration-input image for an initial iteration; wherein the completed respective background image of a preceding iteration is used as the respective iteration-input image for a following iteration, and wherein the method further comprises: for each iteration, generating a respective multiplane image (MPI) based on the respective foreground image obtained in the iteration; for a last iteration, generating an additional MPI based on the completed respective background image of the last iteration; and composing the respective MPIs and the additional MPI into an output MPI representing a frame of the volumetric video corresponding to the frame of the monocular video.

In some embodiments of the above method, each iteration further comprises computing a respective background depth map corresponding to the completed respective background image and a respective foreground depth map corresponding to the respective foreground image; and wherein the respective MPI is further based on the respective foreground depth map.

In some embodiments of any of the above methods, the additional MPI is further based on the respective background depth map of the last iteration.

A non-transitory computer-readable medium storing instructions that, when executed by an electronic processor, cause the electronic processor to perform operations comprising any of the above methods.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in fewer than all features of a single disclosed embodiment. Thus, the following claims are hereby incorporated into the Detailed Description, with each claim standing on its own as a separately claimed subject matter.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Some embodiments may be implemented as circuit-based processes, including possible implementation on a single integrated circuit.

Some embodiments can be embodied in the form of methods and apparatuses for practicing those methods. Some embodiments can also be embodied in the form of program code recorded in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the patented invention(s). Some embodiments can also be embodied in the form of program code, for example, stored in a non-transitory machine-readable storage medium including being loaded into and/or executed by a machine, wherein, when the program code is loaded into and executed by a machine, such as a computer or a processor, the machine becomes an apparatus for practicing the patented invention(s). When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term compatible means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

“BRIEF SUMMARY OF SOME SPECIFIC EMBODIMENTS” in this specification is intended to introduce some example embodiments, with additional embodiments being described in “DETAILED DESCRIPTION” and/or in reference to one or more drawings. “BRIEF SUMMARY OF SOME SPECIFIC EMBODIMENTS” is not intended to identify essential elements or features of the claimed subject matter, nor is it intended to limit the scope of the claimed subject matter.

### REFERENCES

Han Yuxuan, Ruicheng Wang, and Jiaolong Yang. “Single-view view synthesis in the wild with learned adaptive multiplane images.” ACM SIGGRAPH 2022 Conference Proceedings. 2022.
Alexander Kirillov, et al., “Segment Anything,” Proceedings of the IEEE/CVF International Conference on Computer Vision (ICCV), 2023.
Nikhila Ravi, et al., “SAM 2: Segment Anything in Images and Videos,” Arxiv, 2024.
Cheng, Ho Kei, et al., “Putting the Object Back into Video Object Segmentation,” Proceedings of the IEEE/CVF Conference on Computer Vision and Pattern Recognition (CVPR), 2024.
Chen Gao, et al., “Flow-edge Guided Video Completion,” ECCV 2020: 16th European Conference, Glasgow, UK, Aug. 23-28, 2020, Proceedings, Part XII. Springer-Verlag, Berlin, Heidelberg, pp. 713-729.
Robin Rombach, et al., “High-Resolution Image Synthesis with Latent Diffusion Models,” Proceedings of the IEEE/CVF Conference on Computer Vision and Pattern Recognition (CVPR), 2022.
Wei Yin, et al., “Metric3D: Towards Zero-shot Metric 3D Prediction from A Single Image,” Proceedings of the IEEE/CVF International Conference on Computer Vision (ICCV), 2023.
Bingxin Ke, et al., “Repurposing Diffusion-Based Image Generators for Monocular Depth Estimation,” Proceedings of the IEEE/CVF Conference on Computer Vision and Pattern Recognition (CVPR), 2024.
Lei, Chenyang, et al., “Blind Video Deflickering by Neural Filtering with a Flawed Atlas,” Proceedings of the IEEE/CVF Conference on Computer Vision and Pattern Recognition (CVPR), 2023.

What is claimed is:

1. A method of generating a volumetric video based on a monocular video, the method comprising:
obtaining a respective foreground image and a respective background image based on image segmentation of a frame of the monocular video;
completing the respective background image by inpainting one or more occluded areas therein based on one or more neighboring frames of the monocular video;
computing a background depth map corresponding to the completed background image and a foreground depth map corresponding to the respective foreground image;
generating a first multiplane image (MPI) based on the respective foreground image and the foreground depth map;
generating a second MPI based on the completed background image and the background depth map; and
composing the first and second MPIs into a third MPI representing a frame of the volumetric video corresponding to the frame of the monocular video.

2. The method of claim 1, being configured in at least one of the following ways:
wherein the image segmentation is implemented using a vision transformer or a convolutional neural network (CNN), or
generating a video sequence for viewing on a display device by rendering the third MPI in accordance with a selected novel camera pose.

3. The method of claim 1, wherein the image segmentation is implemented based on one or more spatial indicator inputs marking one or more foreground objects in the frame of the monocular video, wherein optionally the one or more spatial indicator inputs are selected from the group consisting of a user click on a foreground object, a bounding box generated via automated object detection, and a text prompt.

4. The method of claim 1, wherein the completing comprises:
estimating an optical flow based on a sequence of frames of the monocular video, the sequence including the frame of the of the monocular video and the one or more neighboring frames; and
applying correlative inpainting to the respective background image based on the estimated optical flow and further based on the sequence of frames.

5. The method of claim 4, wherein the completing further comprises applying generative inpainting to a partially inpainted image obtained with the correlative inpainting.

6. The method of claim 5, wherein the generative inpainting is based on the estimated optical flow, or
wherein the completing further comprises performing two or more iterations directed at obtaining temporal consistency among inpainted background images corresponding to the sequence of frames, each of the iterations including a respective occurrence of the correlative inpainting and a respective occurrence of the generative inpainting.

7. The method of claim 1, wherein computing the background depth map comprises stabilizing the background depth map by applying video deflickering to a sequence of background depth maps corresponding to a sequence of frames of the monocular video, the sequence including the frame and one or more neighboring frames of the monocular video, wherein computing the foreground depth map optionally comprises:
computing an estimated depth map of a full image contained in the frame;
replacing an outlier pixel value in the estimated depth map with a pixel value from a nearest valid pixel to generate a stabilized background depth map;
overwriting a background area of the estimated depth map with the stabilized background depth map to obtain a normalized depth map; and
applying a segmentation mask to the normalized depth map to obtain the foreground depth map.

8. The method of claim 1, further comprising:
computing an estimated depth map of a full image contained in the frame; and
determining a disparities vector \vec{d} based on the full image and the estimated depth map,
wherein each of the first and second MPIs has same MPI plane positions determined based on the disparities vector \vec{d}.

9. The method of claim 8, wherein generating the first MPI comprises:
padding a boundary of a foreground object in the respective foreground image to obtain a padded foreground image;
padding the boundary of the foreground object in the foreground depth map to obtain a padded foreground depth map; and
generating a preliminary foreground MPI based on the padded foreground image and the padded foreground depth map.

10. The method of claim 9, wherein generating the first MPI further comprises performing occlusion correction in the preliminary foreground MPI to generate the first MPI.

11. The method of claim 10, wherein performing the occlusion correction comprises deleting redundant occlusions in the preliminary foreground MPI located outside a conic shape defined by a maximum range of camera movement allowed for MPI rendering and further defined by a geometric shape of the foreground object.

12. The method of claim 11, wherein the deleting is performed based on a multi-plane binary mask representing the conic shape in the preliminary foreground MPI, and the composing comprises overwriting contents of the first MPI with contents of the second MPI using the multi-plane binary mask.

13. The method of claim 12, wherein the composing further comprises:
applying a first blur to a boundary of the multi-plane binary mask; and
applying a second blur to an edge of the multi-plane binary mask.

14. The method of claim 1, further comprising generating a video sequence for viewing on a display device by rendering the third MPI in accordance with a selected novel camera pose.

15. A non-transitory computer-readable medium storing instructions that, when executed by an electronic processor, cause the electronic processor to perform operations comprising the method of claim 1.

16. An apparatus for generating a volumetric video based on a monocular video, the apparatus comprising:
at least one processor; and
at least one memory including program code,
wherein the at least one memory and the program code are configured to, with the at least one processor, cause the apparatus at least to:
obtain a respective foreground image and a respective background image based on image segmentation of a frame of the monocular video;
complete the respective background image by inpainting one or more occluded areas therein based on one or more neighboring frames of the monocular video;
compute a background depth map corresponding to the completed background image and a foreground depth map corresponding to the respective foreground image;
generate a first multiplane image (MPI) based on the respective foreground image and the foreground depth map;
generate a second MPI based on the completed background image and the background depth map; and
compose the first and second MPIs into a third MPI representing a frame of the volumetric video corresponding to the frame of the monocular video.

17. A method of generating a volumetric video based on a monocular video, the method comprising:
iteratively obtaining a plurality of layers representing a frame of the monocular video, the plurality of layers including at least three layers corresponding to different respective nonoverlapping depth ranges,
wherein each iteration comprises:
obtaining a respective foreground image and a respective background image based on image segmentation of a respective iteration-input image; and
completing the respective background image by inpainting one or more occluded areas therein based on one or more neighboring frames of the monocular video;
wherein the frame of the monocular video is used as the respective iteration-input image for an initial iteration;
wherein a completed respective background image of a preceding iteration is used as the respective iteration-input image for a following iteration, and
wherein the method further comprises:
for each iteration, generating a respective multiplane image (MPI) based on the respective foreground image obtained in the iteration;
for a last iteration, generating an additional MPI based on the completed respective background image of the last iteration; and
composing the respective MPIs and the additional MPI into an output MPI representing a frame of the volumetric video corresponding to the frame of the monocular video.

18. The method of claim 17,
wherein each iteration further comprises computing a respective background depth map corresponding to the completed respective background image and a respective foreground depth map corresponding to the respective foreground image; and
wherein the respective MPI is further based on the respective foreground depth map.

19. The method of claim 18, wherein the additional MPI is further based on the respective background depth map of the last iteration.

20. An apparatus for generating a volumetric video with a processor according to the method of claim 17.
